(19) United States
(12) Patent Application Publication
(10) Pub. No.: US 2002/0124085 A1
(43) Pub. Date: Sep. 5, 2002

(54) Method of simulating operation of logical unit, and computer-readable recording medium retaining program for simulating operation of logical unit

(75) Inventors: Akio Matsuda, Kawasaki (JP); Qiang Zhu, Kawasaki (JP); Kazuhiro Matsuzaki, Kawasaki (JP); Takeshi Doi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/964,591

(22) Filed: Sep. 28, 2001

(30) Foreign Application Priority Data
Dec. 28, 2000 (JP) 2000-403135

(51) Int. Cl. G06F 15/173; G06F 15/16; G06F 7/00; G06F 17/30

(52) U.S. Cl. 709/226; 709/203; 707/10

(57) ABSTRACT

A thread manager makes a request to a resource manager for a hardware resource needed for execution of a thread representative of a function of a logical unit, the resource manager allocates the resource in response to the request, and the thread manager controls an execution state of the thread in accordance with a result of the allocation. The thread and resource managers conduct the request, the allocation and the control repeatedly in cooperation with each other until the execution of the thread reaches completion, thus achieving a simulation of the operation of the logical unit. Accordingly, through the operation simulation, it is possible to make the confirmation of the function and the evaluation of an architecture at an initial stage of the design of the logical unit, and further to cope flexibly with an alteration of the architecture by means of a minimum change of description.

### BACKGROUND OF THE INVENTION

(1) Field of the Invention

The present invention relates to a method of simulating an operation of a logical unit and a computer-readable recording medium retaining a program for simulating an operation of a logical unit, suitable for use in operation simulation for the purpose of verification of functions (features) or performance of logical units such as LSI (large Scale Integrated circuit) or IC (Integrated Circuit) on design.

(2) Description of the Related Art

A conventional design of a logical unit has frequently started with an RT (Register Transfer) level through the use of an HDL (Hardware Description Language). However, this RT level is a technique designed for hardware with clock cycle accuracy; for this reason, difficulty is encountered in expressing a logical unit at an initial design stage, where hardware and software are not clearly separated from each other, for verifying its functions or evaluating its performance.

Therefore, so far, there have been proposed many design approaches using languages [for example, C/C++, UML (Unified Modeling Language), SDL (Specification and Description Language), and others]. For example, there are the following documents:

1) “Hardware-Software Co-design of Embedded Systems—The POLIS approach” (F. Balarin, E. Sentovich, M. Chiodo, P. Giusto, H. Hsieh, B. Tabbara and A. Jurecska, L. Lavagno, C. Passerone, K Suzuki and A. Sangiovanni-Vinventelli, Kluwer Academic Publishers, 1997.);

2) “Coware—a design environment for heterogeneous hardware/software partitioning problem” (K. Rompaey, D. Verkest, I. Bolsens and H. DeMan, Proceedings EuroDAC, 1996);

3) “An Object Oriented Programming Approach for Hardware Design” (S. Vernalde, P. Schaumont and I. Bolsens, IEEE Computer Society Workshop on VLSI, April, 1999.);

4) “A Methodology and Design Environment for DSP ASIC Fixed PointRefinement” (R. Cmar, L. Rijnders, P. Schaument, S. Vernalde and I. Bolsens, Processings Design and Test in Europe Conference, pp. 271-276, March, 1999.);

5) “Hardware Reuse at the Behavioral Level” (P. Schaumont, R. Cmar, S. Vernalde, M. Engels and I. Bolsens, The proceedings of 36th Design Automation Conference. ACM, 1999, pp. 784-789, June 1999.);

6) “An Efficient Implementation of Reactivity for Modeling Hardware in the SCENIC Design Environment” Stan Liao, Steve Tijang and Rejesh Gupta, Proceedings of the Design Automation Conference DAC'97, pp. 70-75, June 1999.);

7) “SpecC System-Level Design Methodology Applied to the Design of a GSM Vocoder” (A. Gerstlauer, S. Zhao, A. Horak and D. Gajski, Proceedings of the Workshop on Synthesis And System Integration of Mixed Technologies, April, 2000.); and

8) “On the use of C++ for system-on-chip design” (Diederik Verkest, Johan Cockx and Freddy Potargent, Proceedings of the IEEE Workshop on VLSI (IWV), pp. 42-47, April, 1999.)

These design approaches employ a software thread [reference documents: “Parallel Operating System” (Corona Co., Ltd., written by Hikaru Fukuda, pp. 30, 1997.), “Java Thread Programming” (Ohmsha Co., Ltd., written by Scott Oaks and Henry Wong, translated by Toyokazu Tomatsu and Toshihiro Nishimura, 1997.), and others] for realizing parallel/concurrent processing in a logical unit.

That is, each thread is mapped out in one processing block to define a “communication function” function among blocks, thereby realizing a simulation for a logical unit.

In this case, there are two factors exerting influence on the design cost of a logical unit: one is manual re-working and the other is reuse of the design.

That is, the design cost increases with an increase in frequency of manual re-working. In particular, in the case of a direct RT-level design from a design specification (which will be referred to hereinafter as a “specification”) through the use of HDL, if a packaging design starts without confirmation of the specification, when the package result does not satisfy the required specification, a need for reviewal of the specification occurs so that the re-design of the packaging design becomes frequently necessary. This causes a factor lengthening the design time. In this case, the requirement for improvement is early and precise performance estimate.

On the other hand, with respect to the design reuse, there are two kinds of reuse possibilities: one is reuse of a module designed previously and the other is reuse of a description (source code) in an intermediate stage of a design. For example, in a case in which a need for re-design occurs stemming from an estimate result of performance from the middle of a design on, a need for alteration of the source code exerts influence on the design cost. From this viewpoint, a manner of designing the RT level directly from the specification results in a high design cost. This is because, in the worst case, there may be a need to again make the description at all the RT levels.

From the above, apparently, the start of a direct RT-level design process based on a specification leads to an increase in design cost. For eliminating this problem, there has been proposed a system precedence designing method. For example, as the system precedence designing method, there is a design approach based on stepwise detailed level design or processing, shown in FIGS. 30A and 30B.

The outline of this design approach employing the stepwise detailed level design involves the following designing procedure.

1) Functions (blocks) are extracted from a specification 100 to make out a block diagram (step A1 in FIG. 30A), and an “UnTimed” level functional model, i.e., a functional model in which no consideration is given to time concept, is constructed (described) through the use of C language or the like on the basis of the block diagram made out (step A2 in FIG. 30A, step B1 in FIG. 30B). At this time, if dependence exists between the functions, a “communication” function is defined (described) therebetween, and these functions (blocks) are implemented sequentially.

2) The description of a functional block to be mapped out in hardware is changed to BCA (Bus Cycle Accurate) through a design of an architecture (step B2 in FIG. 30B), and the “communication” function is a bus communication protocol (step B3 in FIG. 30B). At this stage (level), estimate of performance is made (step A3 in FIG. 30A), thereby confirming the specification.

3) The description is further changed to FCA (Full Cycle Accurate) (step B4 in FIG. 30B) to be changed to the actual RT-level description (step A4 in FIG. 30A). At this time, the “communication” function is also incorporated into the description (step A5 in FIG. 30A).

Through the above-mentioned stepwise detailed level design, it is possible to confirm the specification at an early stage, thus realizing a practicable specification.

However, in the case of the above-mentioned conventional method, since the alteration at each level is entirely made manually, a need for an additional design cost arises at the change from the aforesaid “UnTimed” level to the aforesaid BCA level. Add to it that, when reviewal of the design is required from the performance estimate (the aforesaid step A3) at that stage, there is a need to alter the description.

In addition, in the conventional method, since the function (block) configuration reflects an architecture, an alteration of the architecture causes a need for an alteration of the corresponding function (block), accordingly leading to an alteration of the description thereof.

For example, let it be assumed that, as FIG. 31 shows, there is a reason to realize, through the use of the BCA description, a function “1” by a hardware resource “A” (map out the function “1” in the hardware resource “A”), realize a function “2” by a hardware resource ¢B”, and in a state where a “communication” function is defined between these functions “1” and “2”, additionally realize the same function “1” by a plurality of hardware resources “A”.

In this case, the BCA description of the additional function “1” is required to made with respect to each of the hardware resources “A”, and the “communication” function between the functions “1” and “2”, although already defined, are required to be again defined. Thus,since the conventional method is made such that an architecture is reflected in a function (block) configuration, there is a need to entirely change the description of the function (block) whenever a need for an alteration of the architecture arises, which considerably increases the design cost and lowers the design efficiency.

### SUMMARY OF THE INVENTION

The present invention has been developed with a view to eliminating these problems, and it is therefore an object of the invention to perform an operation simulation at an initial stage of a design of a logical unit for confirmation of a function and evaluation of an architecture, and further to cope flexibly with an alteration of the architecture, with a minimum of alteration of the description, thus considerably cutting down the design cost of the logical unit.

For this purpose, in accordance with the present invention, there is provided a logical unit operation simulating method comprising 1) a resource requesting step in which a thread manager, which controls threads each forming an execution unit of a program, makes a request for a hardware resource needed for execution of a thread representative of a function required until an operation of the logical unit reaches completion according to a design specification of a logical unit, to are source manager which manages the hardware resource, 2) a resource allocating step in which the resource manager allocates the hardware resource meeting the request to the thread in accordance with a rule prescribed in advance, and 3) a thread control step in which the thread manager controls an execution state of the thread in accordance with a result of the allocation made by the resource manager, with the thread manager and the resource manager executing the aforesaid steps 1) to 3) repeatedly in cooperation with each other until the execution of the thread reaches completion, for simulating an operation of the logical unit to be conducted up to the completion.

In this case, it is also appropriate that the resource manager monitors resource requests in the resource requesting step 1) to make a decision on a resource request deadlock state among a plurality of threads on a result of the monitoring operation.

In addition, it is also appropriate that the resource manager monitors read/write requests with respect to the hardware resource allocated by the resource request in the resource requesting step 1) to make a decision on a competition state in read/write operation on the hardware resource among a plurality of threads on the basis of a result of the monitoring operation.

Still additionally, it is also appropriate that the resource manager monitors the number of resource requests with respect to the hardware resource to detect a bottleneck on a thread on the basis of a result of the monitoring operation.

Yet additionally, it is also appropriate that the resource manager monitors the number of resource requests with respect to the hardware resource to detect blocking of the resource requests on the basis of a result of the monitoring operation.

Moreover, it is also appropriate that the thread has a budget on a time of occupancy of the hardware resource allocated by the resource manage, or that the thread has an execution time-limit on the aforesaid function.

Still moreover, the logical unit operation simulating method according to the present invention comprises a comparison step of comparing a simulation result obtained through the aforesaid operation simulating method with an estimated value on the operation of the logical unit and an output step of outputting a result of the comparison in the comparison step to an external unit.

Furthermore, in accordance with the present invention, there is provided a computer readable recording medium retaining a program for simulation of an operation of a logical unit, the program making a computer serve as a thread manager for controlling threads each forming an execution unit of the program and as a resource manager for managing a hardware resource needed for execution of each of threads, while the program executing 1) a resource requesting step in which the thread manager makes a request for a hardware resource needed for execution of each of threads representative of a series of functions required until an operation of the logical unit reaches completion according to a design specification of the logical unit, to the resource manager, 2) a resource allocating step in which the resource manager allocates the hardware resource meeting the request to the thread in accordance with a rule prescribed in advance, and 3) a thread control step in which the thread manager controls an execution state of the thread in accordance with a result of the allocation made by the resource manager, with the thread manager and the resource manager executing the aforesaid steps 1) to 3) repeatedly in cooperation with each other until the execution of the thread reaches completion, for simulating an operation of the logical unit to be conducted up to the completion.

Still furthermore, in the computer readable recording medium retaining the logical unit operation simulating program according to the present invention, the operation simulating program further makes the computer execute a comparison step of comparing a simulation result obtained through the operation simulation with an estimated value on the operation of the logical unit and an output step of outputting a result of the comparison in the comparison step to an external unit.

Thus, according to the present invention, a description on a hardware resource (which will hereinafter be referred to simply a “resource”) a “function” to be placed in a logical unit requires is not given to a thread, but the resource manager dynamically allocates a needed resource whenever the thread is executed, and the thread manager and the resource manager repeatedly implement the control of the execution state of the thread in cooperation with each other until the execution of the thread reaches completion, thereby accomplishing the simulation of the operation to be conducted up to the operation completion of the logical unit. Accordingly, this provides the following advantages.

1) Through the comparison with an estimated value on the operation of the logical unit, it is possible to confirm a “function” and confirm the validity of an architecture realizing the “function” at an initial stage of the design, thus enabling function verification and performance evaluation of the logical unit.

2) Through the comparison with an estimated value on the operation of the logical unit, at the initial design stage, it is possible to check whether the “function” has been achieved with precision.

3) Even when the architecture requires an alteration, with a change of the description on the “function” being hardly made, it is possible to easily re-verify the design simply by altering the resource, resource allocation rule, scheduling of the thread, resource request and others in accordance with the alteration of the architecture, which avoids an increase in design cost due to the change of the description on the “function”.

4) In addition, for example, this simulation enables the search for an architecture suitable for the “function”, the evaluation of the performance of the architecture in mapping out the “function” in the architecture and the verification of timing at the initial state of the design.

Moreover, it is also possible that a series of “functions” needed until the operation of the logical unit comes to completion are described by a plurality of sequential thread groups, or that they are represented by a plurality of sequential or concurrent thread groups. In the former case, the operation simulation becomes feasible in a state where the dependence among the “functions” of the logical unit is made clearer, while in the latter case, the operation simulation becomes possible with respect to a logical unit having a more complicated “function” configuration.

Still moreover, it is also possible that a plurality of resource managers are provided in conjunction with the types of resources, for example, that a resource each resource manager takes charge of is allocated to a thread in accordance with a local rule described in advance, or that resource managers are hierarchized according to the dependence among the resources so that the resource allocation is made in consideration of the dependence between the resource each of the resource managers takes charge of and the resource a lower-hierarchy resource manager takes charges of.

In the former case, a simple description (configuration) allows a simulation of a logical unit not having the dependence with respect to the resources, while in the latter case, the resource allocation can be arbitrated globally in additional consideration of the dependence among the resources.

In addition, it is also possible that the aforesaid resource manager monitors resource requests to make a decision on a deadlock state of the resource requests among a plurality of threads on the basis of a result of the monitoring operation. This allows the detection of a possibility of occurrence of the deadlock state at an initial design stage, thus enabling the function verification of a logical unit.

Still additionally, it is also possible that the aforesaid resource manager monitors a read/write request with respect to a resource allocated in response to a resource request to make a decision on a competition state of read/write operations with respect to resources for a plurality of threads on the basis of a result of the monitoring operation. In this case, when a plurality of threads perform sequential writing or reading operations with respect to the resources, it is possible to make a decision on whether the operation order is correct or not, which enables the verification on whether or not the logical unit designed operates correctly.

Yet additionally, it is also possible that the aforesaid resource manager monitors the number of times of resource request to a resource to detect a bottleneck on the threads on the basis of a result of the monitoring operation. In this case, it is possible to make suppositions about the probability that the resource which receives access most frequently effects the bottleneck of the logical unit, thus achieving the verification on the performance of the logical unit (verification on the occurrence/non-occurrence of bottleneck) at an initial stage of the design of the logical unit.

Moreover, it is also possible that the aforesaid resource manager monitors the number of times of resource request to a resource to detect blocking on the resource request on the basis of a result of the monitoring operation. In this case, it is possible to detect the possibility of occurrence of blocking on the resource request, which enables the evaluation of performance of the logical unit.

Still moreover, it is also appropriate that the thread has a function to previously estimate a time of occupancy of the resource allocated by the resource manage. In this case, it is possible to confirm, at an initial design stage, whether or not the logical unit constructed with a combination of various types of “functions” satisfies a performance requirement on a processing time needed according to a design specification.

Yet moreover, it is also appropriate that a function execution time-limit is given to the aforesaid thread. This enables the verification at an initial design stage as to whether or not the logical unit satisfies a real-time performance requirement.

Furthermore, the above-mentioned operation simulating method can also be offered through the use of a computer readable recording medium retaining an operation simulating program which makes a computer operate as mentioned above. In this case, when a computer reads the aforesaid recording medium (when the program is installed in the computer), the computer can function as an apparatus (a logical unit operation simulating apparatus) designed to implement the above-described logical unit operation simulating method. This contributes greatly to the widespread use thereof.

### BRIEF DESCRIPTION OF THE DRAWINGS

FIG. 1 is a block diagram showing a configuration of a computer (information processing apparatus) such as a personal computer according to a first embodiment of the present invention;

FIG. 2 is an illustration of an object model useful for explaining an operation simulating program according to the first embodiment of the invention;

FIG. 3 is an illustration useful for explaining an operation (logical unit operation simulating method) of the computer according to the operation simulating program shown in FIG. 2;

FIG. 4 is a block diagram showing a configuration of an essential part of the computer shown in FIG. 1;

FIG. 5 is an illustration of an example of a description on a thread according to the first embodiment;

FIG. 6 is an illustration of an example of a description on a resource manager according to the first embodiment;

FIG. 7 is a block diagram useful for explaining a “function” needed for a logical unit (QoS system) according to the first embodiment:

FIG. 8 is a flow chart useful for explaining a design procedure (operation simulating method) for a logical unit (QoS system) according to the first embodiment;

FIG. 9 is a block diagram showing a configuration of an essential part of a computer according to a first modification of the first embodiment;

FIG. 10 is an illustration of an example of a description on a thread according to the first modification;

FIGS. 11A and 11B are graphic illustrations useful for explaining the detection of deadlock of a thread according to the first modification;

FIG. 12 is a block diagram showing a configuration of an essential part of a computer according to a second modification of the first embodiment;

FIG. 13 is an illustration of an example of a description on a resource request according to the second modification;

FIG. 14 is an illustration of an example of a description on a resource according to the second modification;

FIG. 15 is a block diagram showing a configuration of an essential part of a computer according to a third modification of the first embodiment;

FIG. 16 is an illustration of an example of a description on a resource according to the third modification;

FIG. 17 is a block diagram showing a configuration of an essential part of a computer according to a fourth modification of the first embodiment;

FIG. 18 is an illustration of an example of a description on a resource according to the fourth modification;

FIG. 19 is a flow chart useful for explaining a design procedure (operation simulating method) for a logical unit according to a fifth modification of the first embodiment;

FIG. 20 is an illustration of an example of a description on a thread according to the fifth modification;

FIG. 21 is a flow chart useful for explaining a design procedure (operation simulating method) for a logical unit according to a sixth modification of the first embodiment;

FIG. 22 is an illustration of an example of a description on a thread according to the sixth modification;

FIG. 23 is an illustrative view useful for explaining a thread generating method according to a seventh modification of the first embodiment;

FIG. 24 is an illustration of an example of a description on a thread according to the seventh modification;

FIG. 25 is an illustrative view useful for explaining a thread generating method according to an eighth modification of the first embodiment;

FIG. 26 is an illustration of an example of a description on a thread according to the eighth modification;

FIG. 27 is a block diagram showing a configuration of an essential part of a computer according to a ninth modification of the first embodiment;

FIG. 28 is an illustration of an example of a description on a resource according to the ninth modification;

FIG. 29 is a block diagram showing a configuration of an essential part of a computer according to a tenth modification of the first embodiment;

FIGS. 30A and 30B are flow charts useful for explaining a conventional design procedure for a logical unit; and

FIG. 31 is an illustration for explaining an object of the conventional logical unit design procedure.

### DESCRIPTION OF THE PREFERRED EMBODIMENTS

Embodiments of the present invention will be described hereinbelow with reference to the drawings.

(A) Description of First Embodiment

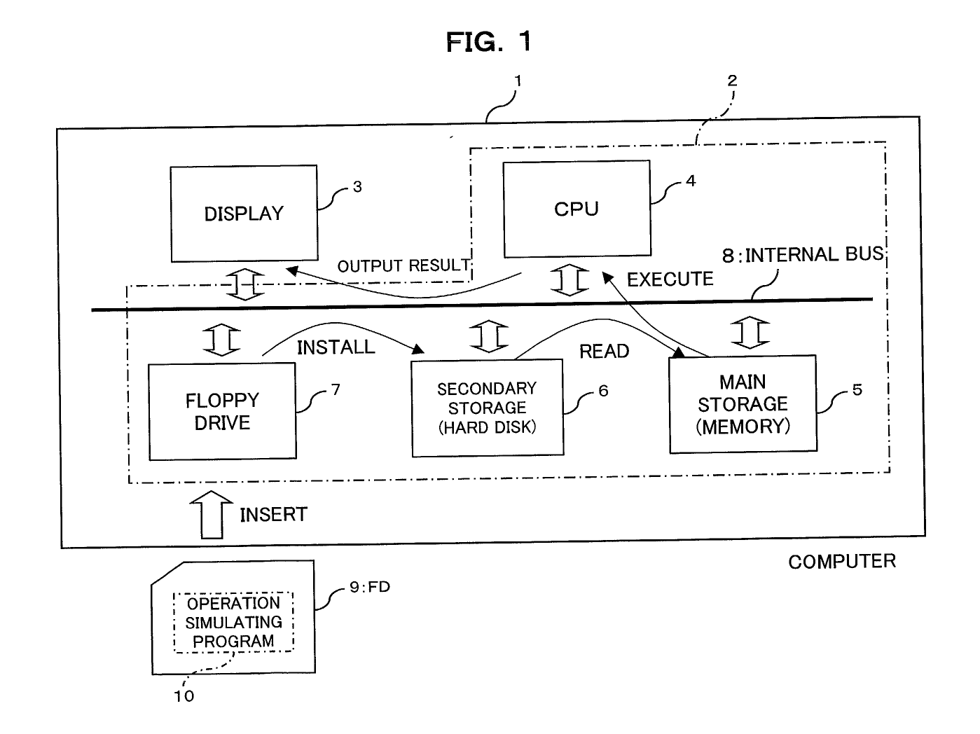

FIG. 1 is a block diagram showing a configuration of a computer (information processing apparatus), such as a personal computer, according to a first embodiment of the present invention. As FIG. 1 shows, the computer, designated generally at reference numeral 1, is made up of a computer body 2 and a display 3, with the computer body 2 (which sometimes will hereinafter be referred to simply as a “body 2”) being, for example, composed of a CPU (Central Processing Unit) 4, a main storage (memory) 5, a secondary storage (hard disk) 6, a floppy disk (FD) drive 7, and other components. These components are interconnected through an internal bus 8 such as a PCI (Peripheral Component Interconnect) to be communicable to each other.

In this case, the CPU 4 is for the purpose of generalizing the operation control of the computer 1, and is designed to fulfill a function needed as the computer 1 (in this embodiment, particularly, a function as a logical unit operation simulating apparatus) by accessing through the internal bus 8 to the memory 5 or the hard disk 6 to read out and implement a needed software (application) program(s) (which hereinafter will equally be referred to simply as a “program”) or application data. The implementation result (including a logical unit operation simulation result) is put on (outputted to) the display 3 according to circumstances.

The hard disk 6 is for storing the aforesaid program, application data, or the like (which sometimes will hereinafter be referred to generally and simply as “various types of data”) previously or by install or the like, with the various types of data being properly read into the memory 5 which permits high-speed access with respect to the CPU 4 so that the CPU 4 can execute the program at a high speed.

The FD drive 7 reads out the various types of data recorded in a floppy disk (FD; recording medium) 9 under control of the CPU 4 to put them in the hard disk 6, thereby providing a function to allow the various types of data to be installed. For example, if a logical unit operation simulating program 10 is recorded in the FD 9, the install of the operation simulating program 10 from the FD 9 (storing in the hard disk 6) allows the computer 1 (CPU 4) to function as a logical unit operation simulating apparatus.

Naturally, at the time that the aforesaid logical unit operation simulating program 10 (which will hereinafter be referred to as simply as a “simulating program 10” or “program 10”) is stored in the hard disk 6 or the memory 5, the hard disk 6 or memory 5 holding that program 10 becomes a recording medium retraining the simulating program 10.

As a matter of course, this program 10 can also be recorded on a CD-ROM, magneto optical disk (MO) or the like, and if a drive or the like capable of handling it is mounted in the body 2, the install from these recording mediums is similarly possible. Moreover, in addition to the install from the recording mediums, the on-line install using a desired communication line (network) such as the Internet is also feasible. That is, the program 10 can be offered not only a recording medium such as FD 9, CD-ROM or MO but also through a desired communication line such as the Internet.

Secondly, a detailed description will be given hereinbelow of the aforesaid simulating program 10.

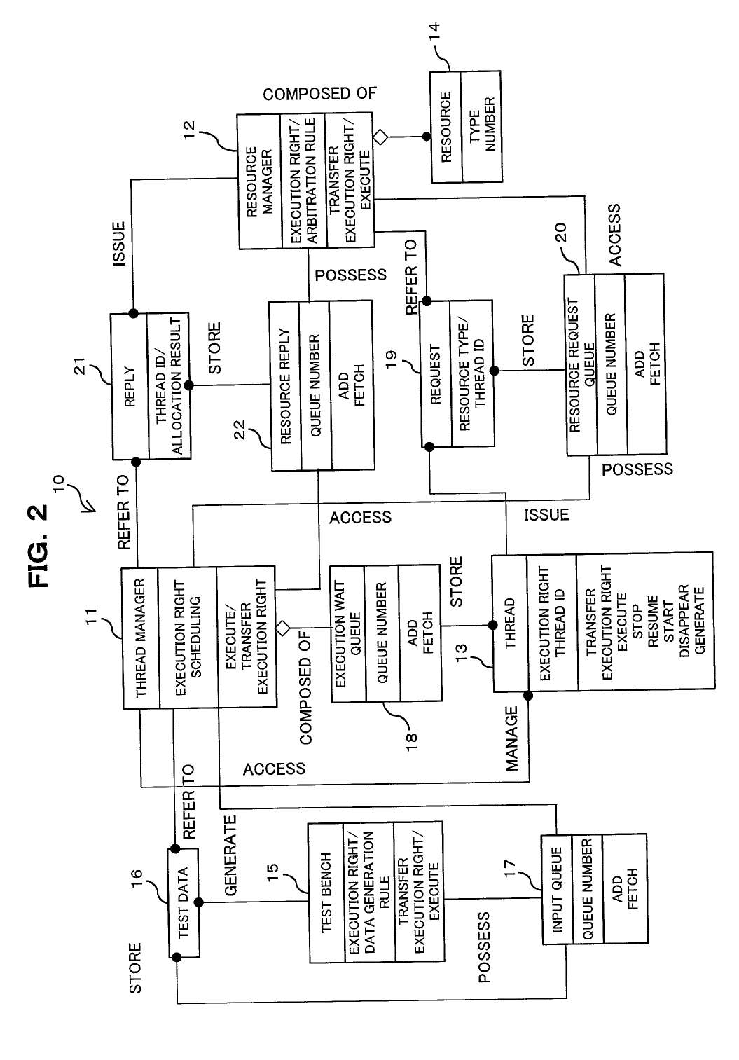

In this embodiment, the simulating program 10 is described (object-oriented-programmed) on the basis of, for example, an OMT (Object-oriented Modeling Technique) shown in FIG. 2, and its essential part defines a thread manager 11, a resource manager 12, a thread 13, a resource 14, a test bench 15, test data 16, an input queue 17, an execution waiting queue 18, a (resource) request 19, a reply 21, a resource reply queue 22 and others as shown in FIG. 2. Incidentally, the “OMT” is explained, for example, in the document “Object-Oriented Modeling and Design” (written by J. Rumbaugh, W. Blaha, W. Premerlani, F. Eddy and W. Lorensen, translated by Eiichi Ikuta, and published by Toppan Co., Ltd., 1995.).

In this configuration, the test bench 15 is for providing a function to generate the test data 16 needed for a logical unit operation simulation according to a predetermined data generating rule and then transferring an execution right to the input queue 17. The test data 16 generated in the test bench 15 are successively stored in the input queue 17 and subsequently fetched successively by the thread manager 11 to be used for generation of the thread 13.

With respect to the thread 13, the functions (called “methods” in the case of OMT) such as “transfer execution right”, “execute”, “halt”, “resume”, “start”, “disappear” and “generate” are defined so that the execution state of the thread 13 is controlled when the execution right is transferred from the thread manager 11.

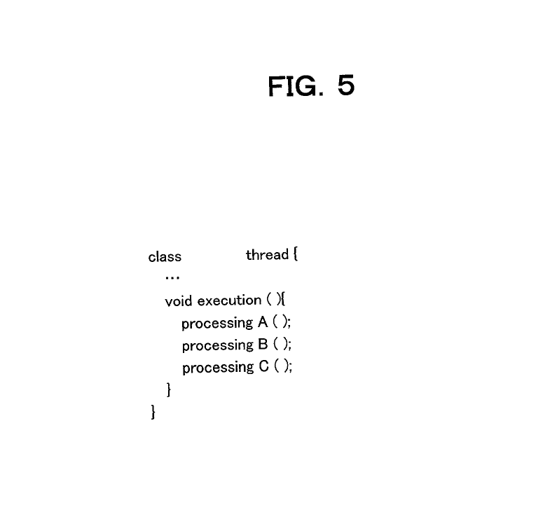

This thread 13 represents an execution unit of a program and, in this embodiment, is described in the form of a sequential flow representative of (defining) the processing (functions) needed between input and output (operation completion) of a logical unit according to a logical unit design specification to be realized. Assuming that the processing (functions) needed between the input and output of the logical unit is processing A→processing B→processing C and these processing are represented in one thread 13, for example, in the case of the employment of the C++ description style, the thread 13 is described as shown in FIG. 5. Also in the following explanation, the C++ description style is applied to the concrete description examples of the simulating program 10, unless otherwise specified particularly.

In addition, when an execution state is reached, the thread 13 independently issues, when there is a need to secure the resource 14 for forwarding the execution (that is, for implementing the “methods”, such as the aforesaid processing A, B and C), a request (resource request) 19 for the resource 14 and, when the secured resource 14 is released, a request (release request) 19 for the release thereof, with these requests being successively stored in the resource request queue 20.

In this embodiment, the resource 14 signifies information about a hardware resource. For example, each of processors, ASICs (Application Specific Integrated Circuits), operation units and other units is defined as resource data.

The execution waiting queue 18 is for providing a function to store an execution waiting thread 13 to each of a plurality of queues, and is aggregated in the thread manager 11.

That is, in this embodiment, the thread manager 11 is composed of the execution waiting queue 18 and one or more threads 13, and it functions as a task for managing the progress (“methods”, such as generation, execution, stop, resumption, disappearance) of the threads 13 and the execution schedule (sequence) of a plurality of threads 13 (controlling the threads 13). In this connection, the next operations of the threads 13 are determined in a manner that this thread manager 11 fetches the reply 21, issued from the resource manager 12, from the resource reply queue 22 to refer to it (the details will be described later).

The resource manager 12 manages resources 14 (type and number) needed for the progress of the threads 13 (the execution of the “methods”), and allocates a resource 14 corresponding to a resource request 19 to the request issuing thread 13 while arbitrating resource requests 19 per unit time at every resource 14 type in accordance with the aforesaid “arbitration rule” prescribed in advance.

In this case, the result of allocation of the resource 14 by the resource manager 12 is issued as the reply 21, and is once stored in (added to) the resource reply queue 22 and then fetched (dequeued) therefrom by the thread manager 11 to be referred to. Moreover, the aforesaid “unit time” signifies a minimum time unit to be taken for when the resource manager 12 performs the arbitration among the resources 14.

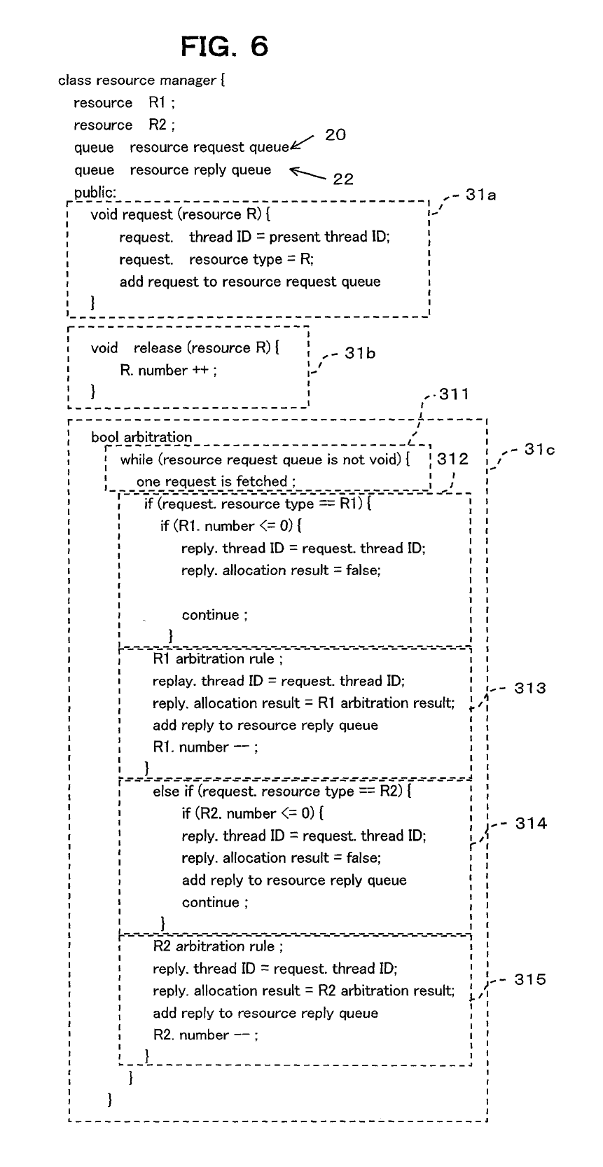

If this resource manager 12 is described in the C++ description style as well as the thread 13, then it becomes, for example, as shown in FIG. 6. That is, for example, the types of the resources (R) 14 the resource manager 12 manages are set as “R1” and “R2”, thus defining the aforesaid resource request queue 20 and resource reply queue 22.

In addition, defined are a request method 31a, a release method 31b for release of the resource 14 and an arbitration method 31c for arbitration of the resource 14. In this case, the request method 31a is a function to clearly designate, as a parameter, which type of resource 14 (“R1” or “R2”) is requested, and register, as a request message, the resource 14 requested and the thread ID of the thread 13 which has issued that request 19 in the resource request queue 20.

The release method 31b is a function to release the resource 14 and increment the number of the released resources 14 by one, while the arbitration method 31c is a function to arbitrate the resource allocation at every type (“R1”, “R2”) of the resource 14 in accordance with the corresponding “arbitration rule”, and except that the resource request queue 20 is void, on the basis of the description given in a frame 311 indicated by a broken line, the request 19 is fetched one by one from the resource request queue 20, and for example, if the type of the resource 14 is “R1”, the descriptions in the broken line frames 312 and 313 are executed, while if the type of the resource 14 is “R2”, the descriptions in the broken line frames 314 and 315 are executed.

The descriptions in the broken line frames 312 and 314 signify that, if the number of the resources 14 (“R1” or “R2”) requested is 0 or less, then the resource 14 to be allocated does not exist, and “False” is stored as a reply 21 on the resource allocation result in the resource reply queue 22.

In addition, the descriptions in the broken line frames 313 and 315 signify that, in the other cases, that is, if the number of the resources 14 (“R1” or “R2”) requested is one or more, because the allocation is possible, the resource 14 is allocated in accordance with the arbitration rule for that resource 14 and the arbitration (allocation) result is placed as a reply 21 in the resource reply queue 22.

With the above-mentioned arrangement, the simulating program 10 according to this embodiment can operates the computer 1 (CPU 4) (makes the computer 1 function) as follows.

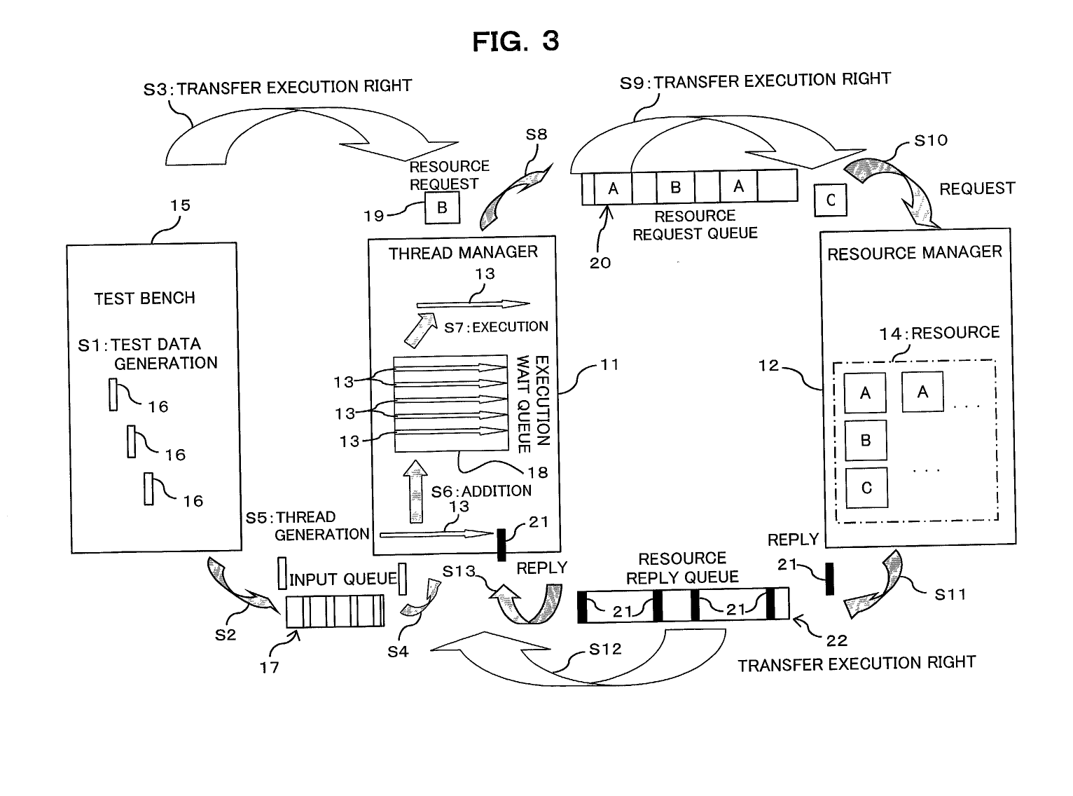

That is, as illustratively shown in FIG. 3, first, the test bench 15 generates test data 16 in accordance with the “test generating rule” prescribed (step S1), and adds it to the input queue 17 (step S2).

After the generation of all the test data 16, the test bench 15 transfers the execution right to the thread manager 11 (step S3). When acquiring the execution right, the thread manager 11 fetches the test data 16 from the input queue 17 (step S4) to generate a thread 13 corresponding thereto (step S5; thread generating step), and adds it to the execution waiting queue 18 (step S6). At this time, the thread 13 is in anon-initiation condition, that is, conducts no execution.

In addition, the thread manager 11 fetches the execution waiting thread 13 from the execution waiting queue 18 after the input queue 17 is void, and if that thread 13 is in the non-initiation condition, executes and sets it into an “execution condition” (step S7). When entering the “execution condition”, the thread 13 makes a request to the resource manager 12 for securing the resource 14 needed for the first “method” (for example, issues a resource request 19 for the resource “B” of the resources “A” to “C”; step S8,resource request step). This resource request 19 is added through the thread manager 11 to the resource request queue 20. Moreover, the thread 13 which has issued this resource request 19 is added to the last of the execution waiting queue 18.

Following this, after the completion of the processing (execution) of all the threads 13 stored in the execution waiting queue 18, the thread manager 11 transfers the execution right to the resource manager 12 (step S9) . On the acquisition of the execution right, the resource manager 12 fetches the resource requests 19 successively from the head of the resource request queue 20 (step S10), and allocates the requested resource 14 to the thread 13 while arbitrating the allocation of the resources 14 in accordance with the present “arbitration rule” and issues the result (whether allocated or not; “True” or “False”) as a reply 21 to add it to the resource the reply queue 22 (step S11; resource allocation step).

In addition, after the completion of the resource allocation processing to all the requests 19 stored in the resource request queue 20, the resource manager 12 transfers the execution right to the thread manager 11 (step S12). When acquiring the execution right, the thread manager 11 fetches the replies 21 successively from the resource reply queue 22 (step S13), and if the contents of the replies 21 show “True” (allocation OK), executes the thread 13 corresponding to the thread ID (at this time, positioned at the head of the execution waiting queue 18) (thread control step) and issues a resource request 19 needed for the execution of the next “method” to add it to the resource request queue 20, subsequently again adding the executed thread 13 to the last of the execution waiting queue 18.

When the reply 21 fetched from the resource reply queue 22 shows “False” (allocation NG), the thread manager 11 again adds the present (previously issued) resource request 19 to the resource request queue 20 and then adds the thread 13 to the last of the execution waiting queue 18 as “waiting condition” (thread control step). When all the processing reach completion (on the completion of the allocation of the resource 14), the thread 13 disappears, and is removed from the execution waiting queue 18.

Thus, the thread manager 11 and the resource manager 12 repeatedly implement the control of the execution state of the thread 13 on the basis of the resource request, the resource allocation and the reply 21 in cooperation with each other until the execution of all the threads 13 (the execution of all the “methods”) reach completion, thereby accomplishing the logical unit operation simulation.

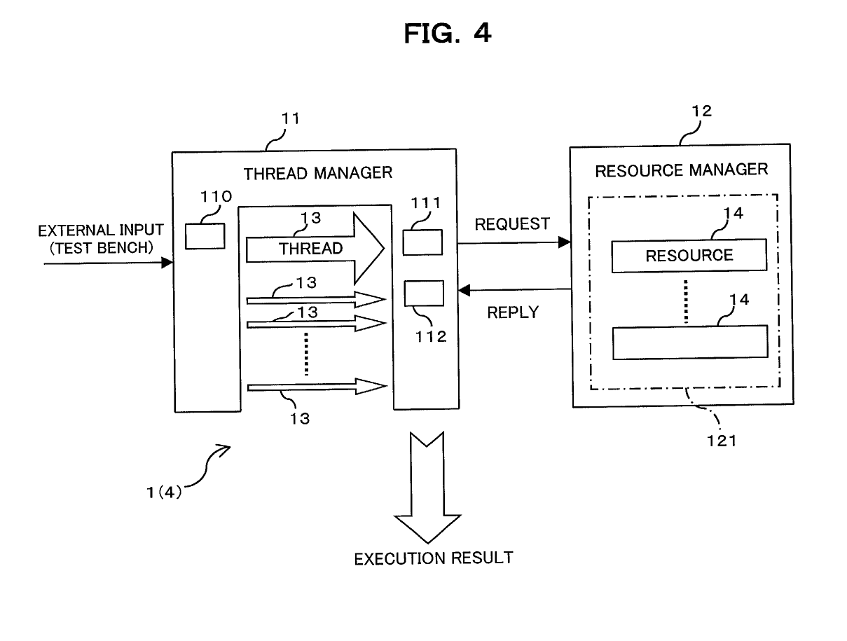

That is, in this embodiment, the thread manager 11 and the resource manager 12 have the following functional sections as illustratively shown in FIG. 4, and the executions of the threads 13 reach completion, they repeatedly execute the control of the resource requests 19 and the execution states of the threads 13 in cooperation with each other, and output the execution result to, for example, the display 3, thus simulating the operations of the logical unit to be conducted up to the completion.

The thread manager 11 has the following functions:

1) a function as a thread generating section 110 for generating, on the basis of the input of test data 16, a thread representative of a function (processing) needed until the completion of operation of a logical unit according to a design specification of the logical unit;

2) a function as a resource requesting section 111 for making a request to the resource manager 12 for a resource 14 needed for execution of a thread 13; and

3) a function as a thread control section 112 for controlling an execution state of a thread 13 on the basis of an allocation result (reply 21) from the resource manager 12 with respect to a request made by the resource requesting section 111.

The resource manager 12 has the following function:

1) a function as a resource allocating section 121 for allocating a resource 14 meeting the resource request 19 to a thread 13 in accordance with a “arbitration rule” prescribed in advance.

In other words, in this embodiment, a description on a hardware resource needed for the “processing (function)” to be involved in a logical unit is not given to a thread 13 (“method”), but at the execution of the “method” of that thread 13, the resource 14 needed is dynamically allocated each time by the resource manager 12. That is, unlike the conventional manner, the “function” to be realized does not reflect an architecture.

Accordingly, the operation simulation is realizable at an initial stage of the design of a logical unit, and at the initial design stage, it is possible to verify a function (algorithm) for precisely realizing a “function” needed depending on a specification, and even when an architecture is required to alter, it is possible to re-verify the design simply by changing, for example, a resource 14, the “arbitration rule” for the resource 14, the scheduling of a thread 13 or a request to the resource 14 according to the alteration without substantially changing the description on the “function”.

In this connection, the re-verification of the design based upon the simple change of the resource 14, the “arbitration rule” for the resource 14, the scheduling of the thread 13, the request to the resource 14 or the like signifies that it is possible to perform, for example, the search for an architecture suitable for the “function”, the evaluation of the performance of the architecture in mapping the “function” in the architecture, and the verification of the timing at the initial design stage.

(A1) Explanation of Concrete Example of First Embodiment

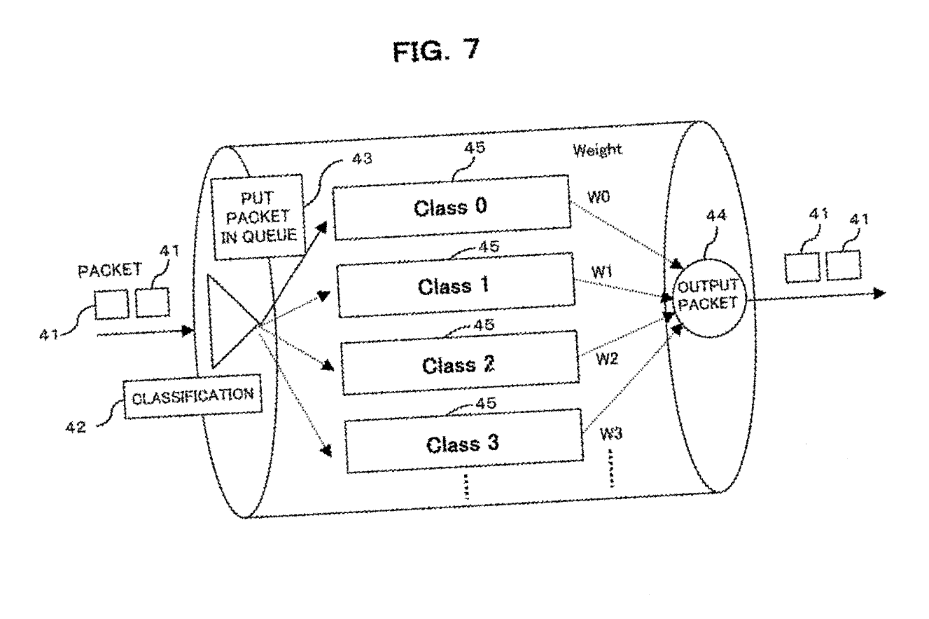

Referring to a concrete example, a more detailed explanation will be given hereinbelow of the foregoing simulating method. That is, this explanation relates to a design of a QoS (Quality of Service) system and an operation simulation therefor. In this case, the “QoS system” is made such that, in a packet transfer apparatus such as an IP (Internet Protocol) router, for example as illustratively shown in FIG. 7, inputted (received) packets 41 are classified according to a given rule and stored in a plurality of packet queues 45 and lastly the packets 41 are outputted from the respective queues 45 so as to satisfy a specified service rate [according to weighting (W0 to W3, or the like) corresponding to a specified service rate]. The detail of the “QoS” exists, for example, in the document “Internet QoS” (written by Paul Ferguson and Geoff Huston, translated by Iwao Toda, and published by Ohmsha Co., Ltd., 2000.)

1) Extraction of Functions from Specification

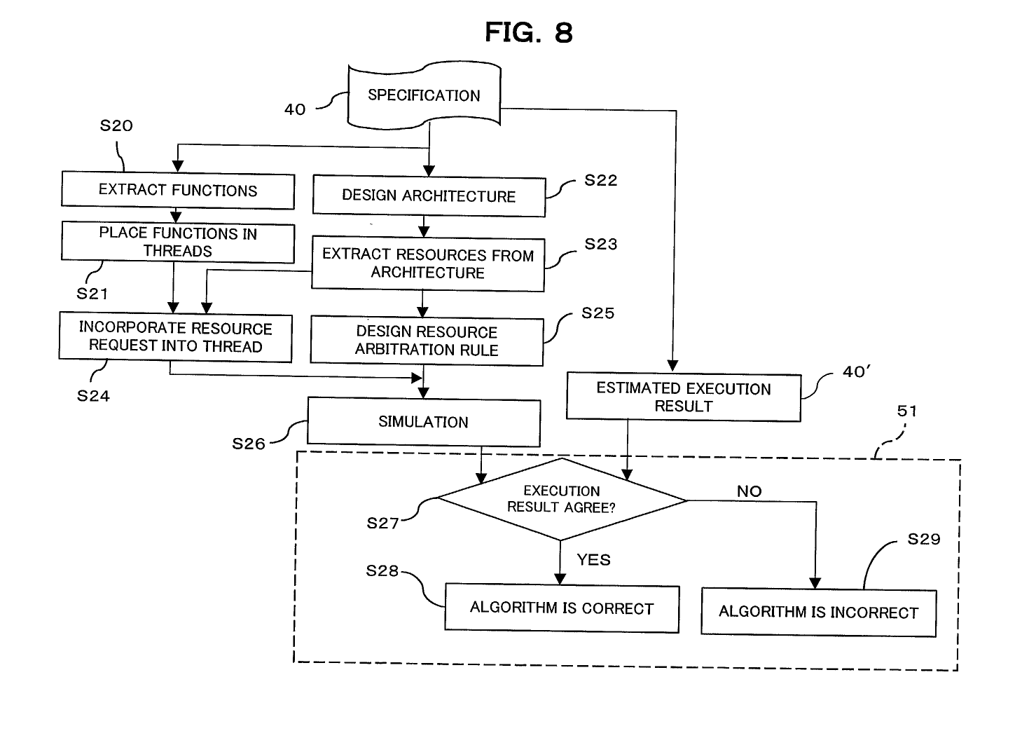

First of all, as an initial step, as shown in FIG. 8, there is a need to extract “functions” of the QoS system, to be realized, from a specification 40 (step S20). That is, in this case, at least the following functions, indicated in (a) to (c), become necessary.

(a) Function 42 for Classifying Packets 41 (see FIG. 7): Classify( )

This function 42 is for classification based on a value of “IP Precedence Field” of a packet header, and in this embodiment, let it be assumed that the classification is made in accordance with, for example, a rule shown in the following table 1.

TABLE 1

| | | Corresponding |
|---|---|---|
| IP Precedence | Class | Queue Number |
| 000 | 0 | 0 |
| 001 | | |
| 010 | 1 | 1 |
| 011 | | |
| 100 | 2 | 2 |
| 101 | | |
| 110 | 3 | 3 |
| 111 | | |

(b) Function 43 for Storing (Queuing) Packets in Queue 45: Queuing( )

This function 43 is for storing packets 41, classified by the aforesaid classifying function 42, in the corresponding queues 45. In each of the queues 45, the maximum number of packets storable (which will be referred to hereinafter as a “maximum size”) is determined in advance, and the packets 41 being out of the maximum size are abandoned.

(c) Function 44 for fetching (dequeuing) Packets from Queues 45: Dequeuing( )

This dequeuing function 44 is for fetching (outputting) packets 41 from the queues 45, and a “service rate” is determined previously with respect to each of the queues 45 so that a determination as to whether or not a packet 41 is outputted from the queue 45 is made on the basis of this “service rate”.

2) Threading of “Functions”

Secondly, the aforesaid functions 42 to 44 are threaded as “methods” (step S21 in FIG. 8). That is, as mentioned above with reference to FIG. 5, a series of processing (functions) of the aforesaid processing A → processing B → processing C are expressed in the form of one thread 13 as follows.

Classify( )→Queuing( )→Dequeuing( )

In this case, this thread 13 takes three kinds of states as shown in the following table 2.

TABLE 2
Thread States

| Thread States | Explanation |
|---|---|
| execution state | thread is in executing |
| | state |
| wait state | thread is in waiting state |
| termination state | thread is in terminated |
| | state |

Each of the aforesaid states depends upon a securing situation (allocation result) of a resource 14, the queuing function 42 [Queuing( )] and a result of the dequeuing function 43 [Dequeuing( )]. For example, in a case in which the queue 45 is already filled up at the execution of the Queuing( ) so that there is a need to abandon the packets 41, the thread 13 shifts from the “execution state” to the “termination state”. In addition, in a case in which difficulty is encountered in securing the resource 14, the thread 13 is added to the last of the execution waiting queue 18 as mentioned above with reference to FIG. 3, thus switching into the “wait state”.

3) Design of Architecture Based on Specification 40

On the other hand, there is a need to design an architecture of the QoS system on the basis of the specification 40 (step S22) . That is, for example, the aforesaid Classify( ) and Queuing( ) are realized on one resource 14 (let it be assumed that it is R2), while the aforesaid Dequeuing( ) is realized on another resource 14 (let it be assumed that it is R2).

At this time, the execution delay time for when the aforesaid Classify( ) is realized on the resource R1 [that is, when Classify( ) secures the resource R1 and is in execution] is taken as T_{1c}, the execution delay time for when the Queuing( ) is realized on the resource R1 is taken as T_{1q}, and the execution delay time for when the Dequeuing ( ) is realized on the resource R2 is taken as T_{2d}.

In addition, in a case in which competition on the resource R1 occurs, a request from the Classify( ) is treated preferentially, and when competition on the resource R2 occurs, the resource allocation is made in the order of request arrival. Still additionally, for example, two resources R2 are used in order to enhance the performance of the Dequeuing( ).

4) Extraction of Resource from Architecture

From the above, the number of resources 14 (R1, R2) and the arbitration rule are defined as shown in the following table 3 (step S23 in FIG. 8).

TABLE 3
Resource List

| Resource name | Number | Arbitration Rule |
|---|---|---|
| R1 | 1 | Classify() is treated |
| | | preferentially |
| R2 | 2 | first arrival request |
| | | is treated |
| | | preferentially |

5) Incorporation of Resource Request into Thread 13

Subsequently, for executing the aforesaid Classify( ), Queuing( ) and Dequeuing( ), there is a need to secure the aforesaid resources R1 and R2 (incorporate a resource request into the thread 13; step S24 in FIG. 8). That is, there is a need to conduct (describe) the following processing (1) to (5).

i) On arrival of packets 41, a thread 13 is generated dynamically, and falls into an execution state.

ii) A request f or securing the resource R1 is made in order to execute the Classify( ) (a request 19 is issued for the resource R1). When secured, the next step is conducted [Classify( )is executed]. If not secured, that thread 13 falls into the “wait state”. In a subsequent step (when the thread 13 switches next into the “execution state”), a request for securing the resource R1 is made again.

iii) After the execution of the Classify( ), a request for securing the resource R1 is made in order to execute the Queuing( ). When secured, the next step takes place [Queuing( ) is executed]. If not secured, the thread 13 falls into the “wait state”, and in a subsequent step (when the thread 13 switches next into the “execution state”), a request for securing the resource R1 is made again.

iv) After the execution of the Queuing( ), a request for securing the resource R2 is made in order to execute the Dequeuing( ). When secured, the next step takes place [Dequeuing( ) is executed]. If not secured, the thread 13 falls into the “wait” state, and in a subsequent step (when the thread 13 switches next into the “execution state”), a request for securing the resource R2 is made again.

v) After all the processing reach completion, the thread 13 is set in the terminated condition.

6) Description of Resource Arbitration Rule

When a plurality of threads 13 then make a request for the same resource 14 (R1 or R2), the competition on the resource 14 occurs, so there is a need to define the “arbitration rule” (step S25 in FIG. 8).

First, the “arbitration rule” on the resource R1 (corresponding to “R1 arbitration rule” in the broken line frame 313 shown in FIG. 6) is described to realize the following procedure.

i) A decision is made as to whether or not the resource R1 is in a free condition. If not free, a reply 21 to the effect of rejection of the allocation is issued with respect to all the requests 19. If free, the next step takes place.

ii) If, of the requests 19 within a unit time, are source request for execution of the Classify( ) exists, the resource R1 is allocated to that thread 13 (if a plurality of threads 13 exist, the thread 13 which has issued the first request 19). If there is no resource request 19 for the execution of the Classify( ), the resource R1 is allocated to the thread 13 which has issued the first request 19. A reply 21 to the effect of rejection of the allocation is issued with respect to the other requests 19.

On the other hand, the “arbitration rule on the resource R2 (corresponding to “R2 arbitration rule” in the broken line frame 314 shown in FIG. 6) is described to realize the following procedure.

i) A decision is made as to whether or not the resource R2 is currently in a free condition. If not free, a reply 21 to the effect of rejection of allocation is issued with respect to all the requests 19. If free, the next step takes place.

ii) The resource R1 is allocated to the thread 13 which has issued, of the requests 19 within a unit time, the first request. A reply 21 to the effect of rejection of the allocation is issued with respect to the other requests 19.

7) Simulation

The “functions” needed for the QoS system are programmed in this way (construction of a simulation program 10) and are executed on the computer 1 (CPU 4) to conduct the simulation on the operation of the QoS system (step S26 in FIG. 8). That is, the computer 1 (CPU 4) acts as the thread manager 11 and the resource manager 12 as mentioned above with reference to FIGS. 3 and 4, thereby accomplishing the QoS system operation simulation.

8) Comparison between Simulation Result and Estimated Value

The above-mentioned simulation produces one simulation result. That is, for example, it is found that the packets 41 are outputted at a given rate. In addition, through the comparison (step S27 in FIG. 8; comparison step) between this simulation result and a operation result (estimated value) 40′ estimated from the specification 40, a decision is made as to whether an algorithm designed is correct (step S28 through YES route from step S27) or incorrect (mistaken design; step S29 through NO route from step S27), and the decision result is outputted to (displayed on), for example, the display 3 acting as an external unit (output step).

That is, the section shown in the broken line frame 51 of FIG. 8 serves as a program (operation simulation program) for the verification of functions of a logical unit, which makes the computer 1 (CPU 4) execute the comparison step (S27) of making the comparison between the simulation result obtained through the aforesaid logical unit simulating method and an estimated value on an operation of the logical unit and the output step of outputting the comparison result in the comparison step (S27) to an external unit such as the display 3.

This program 51 can also be recorded on a recording medium such as FD 9, CD-ROM, MO or the like, and when the program 51 recorded on the recording medium is installed in the computer 1 (recorded in the hard disk 6), the computer 1 (CPU 4) can be operated as mentioned above.

Moreover, in the case of a mistaken design (for example, the number of packets 41 abandoned exceeds the number prescribed), for example, by means of changing the size of the queue 45 [altering the description about the queue 45 (resource 14)], the aforesaid simulation is made until the optimum architecture is acquired, thus searching for an architecture optimal to the QoS system.

In the above-mentioned case, the aforesaid estimated value can be calculated on the basis of the aforesaid Classify( ) execution delay time T_{1c}, Queuing( ) execution delay time T_{1q} and Dequeuing( ) execution delay time T_{2d}. In addition, the comparison result between the simulation result and the estimated value can also be outputted not only to the display 3 but also to peripheral equipment such as a printer.

Thus, the verification of the functions of the QoS system serving as a logical unit (verification as to whether or not to satisfy the requirements as a system) can be made at an initial stage of the system design. In addition, even if the alteration of the architecture becomes necessary, the re-verification of the design (algorithm) is easily achievable simply by changing, according to that alteration, the resource 14 (R1, R2) to be put to use, the “arbitration rule” for the resource 14, the scheduling of the thread 13, the request for the resource 14, or the like. Accordingly, it is possible to realize a high-flexibility design manner requiring less manual re-working and less alteration of the description style (that is, description style excellent in reuse), thereby cutting down the system design cost considerably.

(B) Description of First Modification

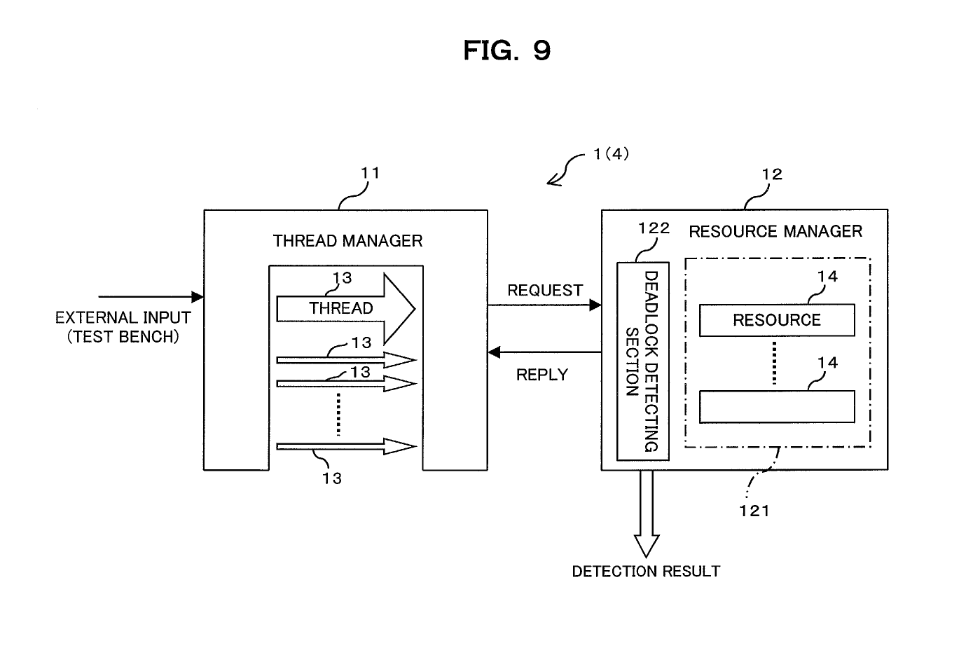

Meanwhile, a deadlock detecting section 122 is additionally provided in the above-mentioned resource manager 12 as shown in FIG. 9. This deadlock detecting section 122 is for detecting whether or not there is a possibility that a “deadlock” condition occurs because a plurality of threads 13 compete with each other to secure a resource 14.

In this case, the “deadlock” signifies a specific state in which two or more threads 13 make a request for a resource 14 the other threads 13 possess but a solution thereto becomes difficult. The “deadlock” is explained in, for example, the document “Basis of Today's Operating System” (written by Hiroshi Hagiwara, Takao Tsuda and Hidetsugu, published by Ohmsha Co., Ltd., pp. 63, 1995.).

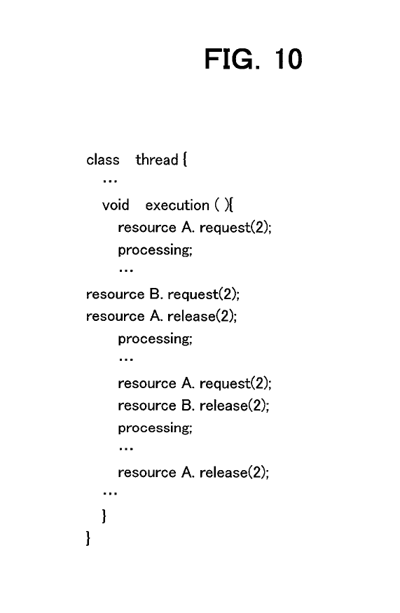

For example, let it be assumed that two threads (thread “1”, thread “2”) each described as shown in FIG. 10 exist, and in this case, the number of resources 14 (“A”) is three and the number of resources 14 (“B”) is two. In FIG. 10, a numeric value (in this case, “2”) indicated in functions (parentheses) such as “Resource A. Request( )” represents a thread ID, and this applies to the following description.

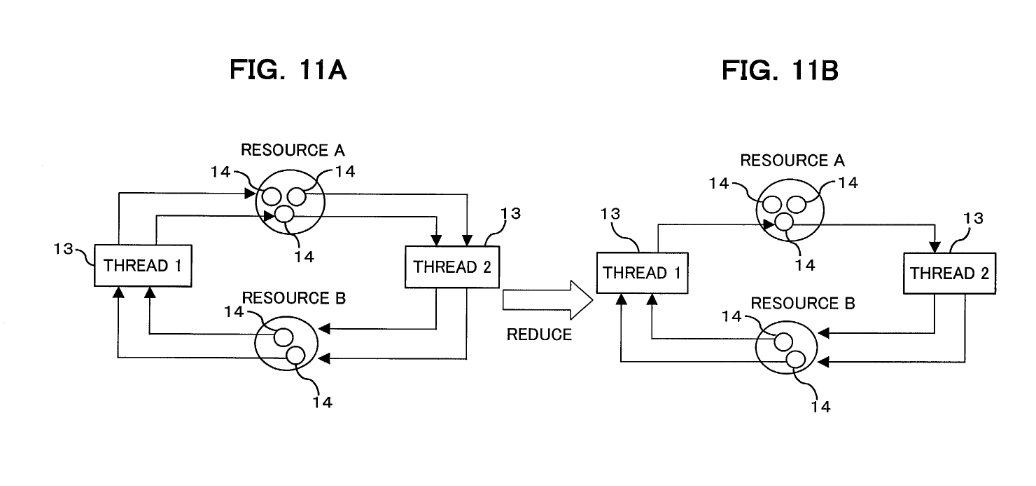

In addition, in such a case, a resource allocation graph for each of the threads “1” and “2” becomes as shown in FIG. 11A.

When the condition shown in FIG. 11A is represented in a state reduced, it becomes as shown in FIG. 1B, and it is found that, in this condition, further reduction is impossible (irreducible).

This means that there is a possibility that the “deadlock” occurs between the thread “1” and the thread “2”. The deadlock detecting section 122 makes a decision about the possibility of the occurrence of the “deadlock” on the basis of the resource allocation graph in this way.

Thus, it is possible to detect the possibility of the occurrence of the “deadlock” at an initial design stage, thus enabling the function verification of the logical unit.

(C) Description of Second Modification

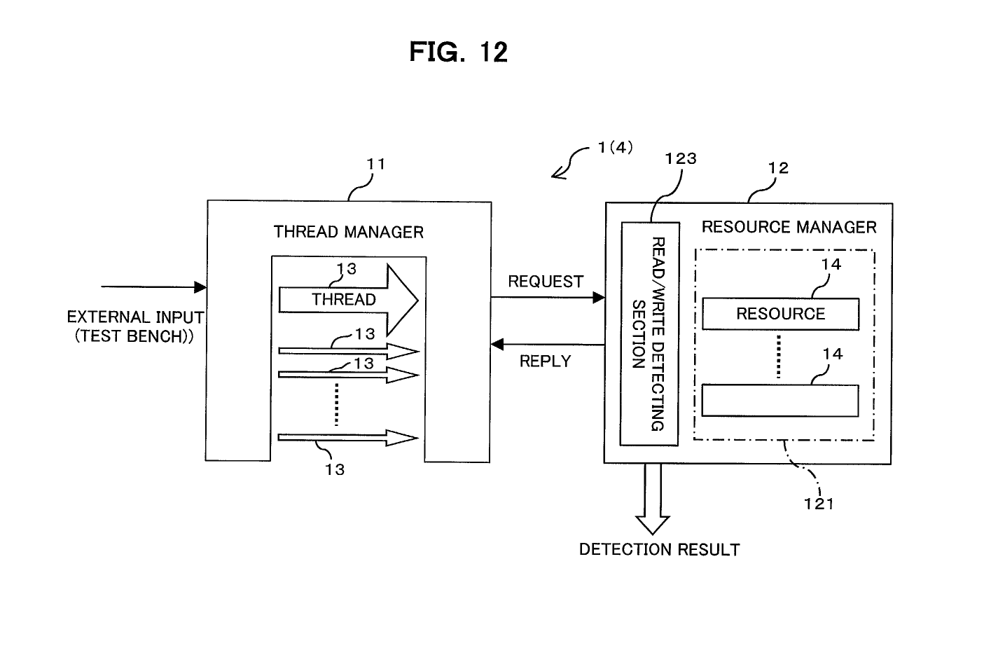

Furthermore, it is also appropriate that a read/write detecting section 123 is additionally provided in the aforesaid resource manager 12, for example, as shown in FIG. 12. This read/write detecting section 123 is for monitoring (detecting) the following events i) to iii) to detect a possibility of the occurrence of a read/write error.

i) The occurrence of a read request and a write request with respect to the same resource 14 within the same unit time;

ii) The occurrence of a read request with respect to a resource already occupied due to a write request; and

iii) The occurrence of a write request with respect to a resource already occupied due to a read request.

That is, the detection result by the read/write detecting section 123 enables a decision as to whether, when a plurality of threads 13 conducts writing operations or reading operations with respect to a resource 14, that the sequence is correct or not (namely, a decision on a competition state in read/write operation among the plurality of threads 13 with respect to the resource 14), which makes it possible to verify whether or not a logical unit designed conducts a correct operation.

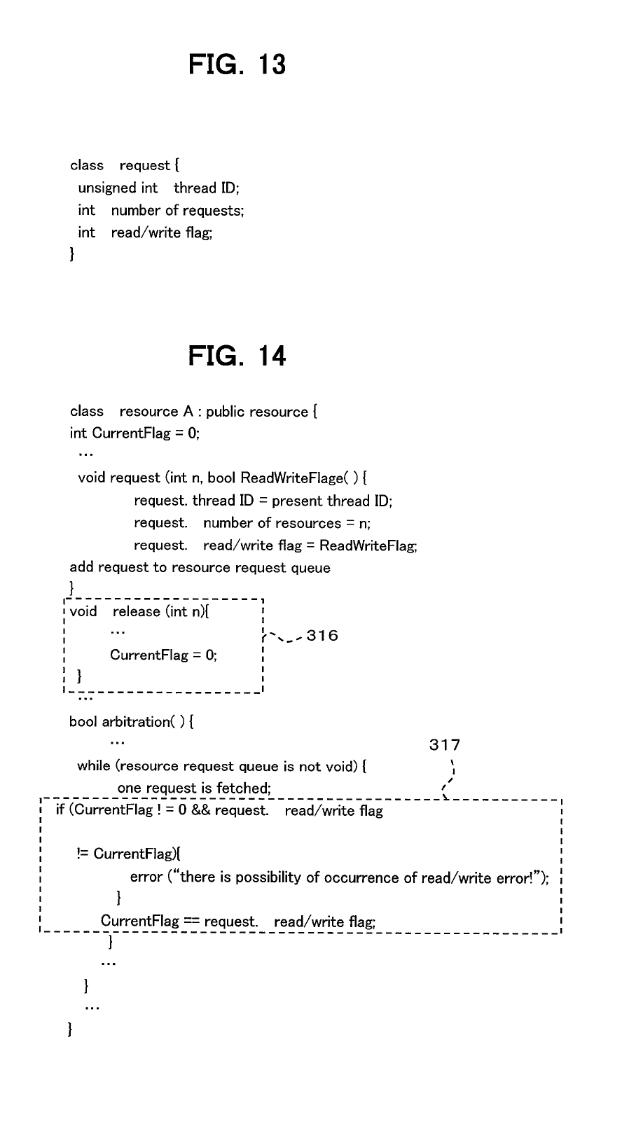

For realizing this, a description on a request 19 is extended, for example, as shown in FIG. 13. That is, “read/write flags” are defined as shown in the following table 4.

TABLE 4

| | |
|---|---|
| read/write flag = 0 | no consideration of read/write |
| read/write flag = 1 | read request |
| read/write flag = 2 | write request |

In addition, the description on the resource 14 is extended, for example, as shown in FIG. 14. That is, in the case of release of the resource 14, a “CurrentFlag” is always set at “0” (see a broken line frame 316), and when this “CurrentFlag” is not “0”, if the “read/write flag” on the request 19 and the “CurrentFlag” on the resource 14 side do not agree with each other, error information such as “there is a possibility of occurrence of read/write error” is outputted to the display 3 or the like (see a broken line frame 317).

(D) Description of Third Modification

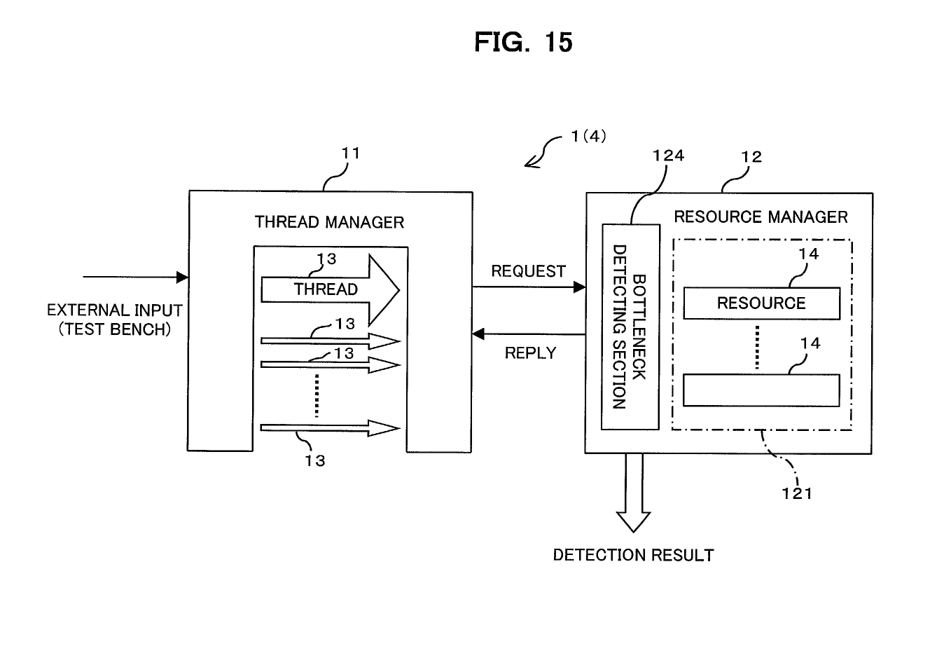

Furthermore, it is also appropriate that a bottleneck detecting section 124 is additionally provided in the aforesaid resource manager 12, for example, as shown in FIG. 15. This bottleneck detecting section 124 is for detecting a “bottleneck” on the basis of an execution result of a thread 13 or an access situation to a resource 14. For example, a simulation is made under an environment in which limitation is imposed on the number and type of resources 14 to confirm the number of times of access to each of the resources 14, a waiting time in the case of no allocation thereto, or the like, thereby enabling the detection of a “bottleneck” portion of a logical unit.

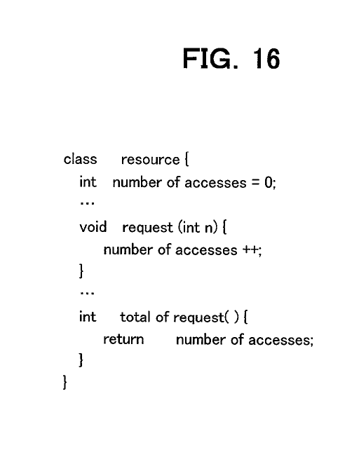

Concretely, for example, as shown in FIG. 16, a “method” for counting the number of requests (number of times of access) is added to the description on the resource 14, and the count result is made to be accessed by a “request total member function [request total( )]”, which allows a mechanism for monitoring the number of times of access to the resource 14 to be realized in the resource manager 12.

That is, when the bottleneck detecting section 124 accesses the “request total member function” of each of the resources 14, it is possible to examine the access frequency until now to each of the resources 14. For example, it can be considered that the resource 14 showing the highest access frequency creates a “bottleneck” of the logical unit. Accordingly, the performance verification of the logical unit (verification on the presence or absence of the bottleneck) is feasible at an initial stage of the design of the logical unit.

(E) Description of Fourth Modification

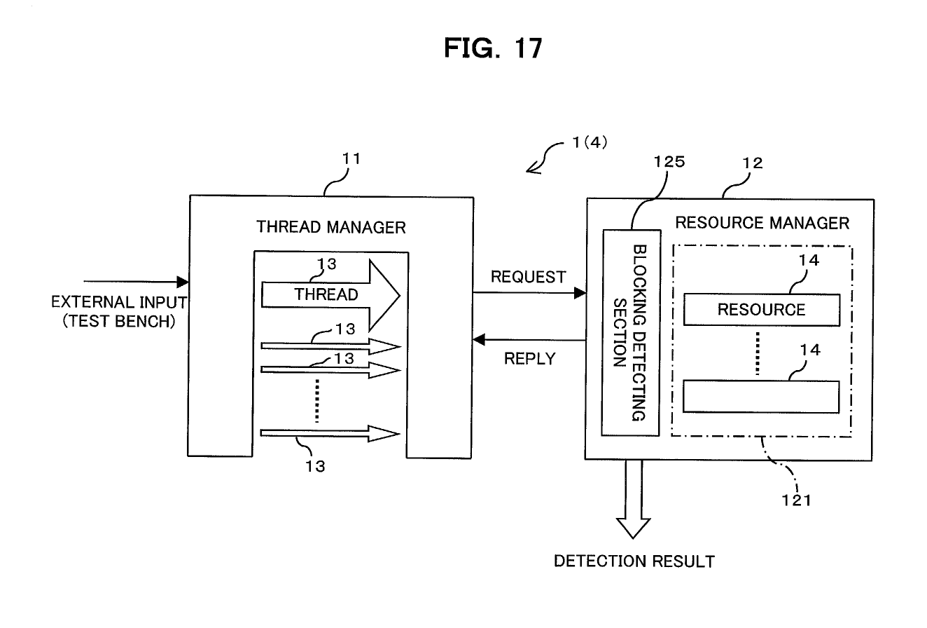

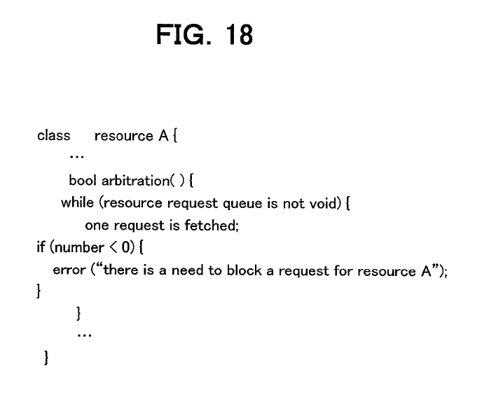

Moreover, it is also appropriate that a blocking detecting section 125 is additionally placed in the aforesaid resource manager 12, for example, as shown in FIG. 17. This blocking detecting section 125 is for providing a function to examine a situation on the occurrence of “blocking” in a case in which the number of requests 19 for resources 14 from threads 13 exceeds a predetermined limiting value. This is realizable, for example, by add a description shown in FIG. 18 to the resource 14.

In addition, a simulation is made under an environment that the “number” of resources 14 is limited (determined in advance), and if there are requests 19 larger in number than the number of resources allocatable [in the case of satisfying “if” condition (“number”<0)], it can be considered that the “blocking” has occurred, so error information such as “there is a need to block requests for a resource A” is outputted to the display 3 or the like.

Thus, in this modification, the blocking detecting section 125 examines a possibility of the “blocking” to be conducted for when, under the environment that limitation is imposed on the “number” of resources 14, the number of resource requests from the threads 13 exceeds a limiting value, thereby evaluating the performance of the logical unit.

Incidentally, the above-mentioned deadlock detecting section 122, read/write detecting section 123, bottleneck detecting section 124 and blocking detecting section 125 in the first to fourth modification can all or partially be combined according to verification items for a logical unit and placed in the resource manager 12.

(F) Description of Fifth Modification

Meanwhile, it is also appropriate that, in the thread 13, a “time budget”, which is an estimated value of an execution time needed for a series of processing (“functions”; “methods”) described in that thread 13 (that is, a budget on time for which a resource 14 allocated by the resource manager 12 is occupied), is set with respect to each of the “functions”.

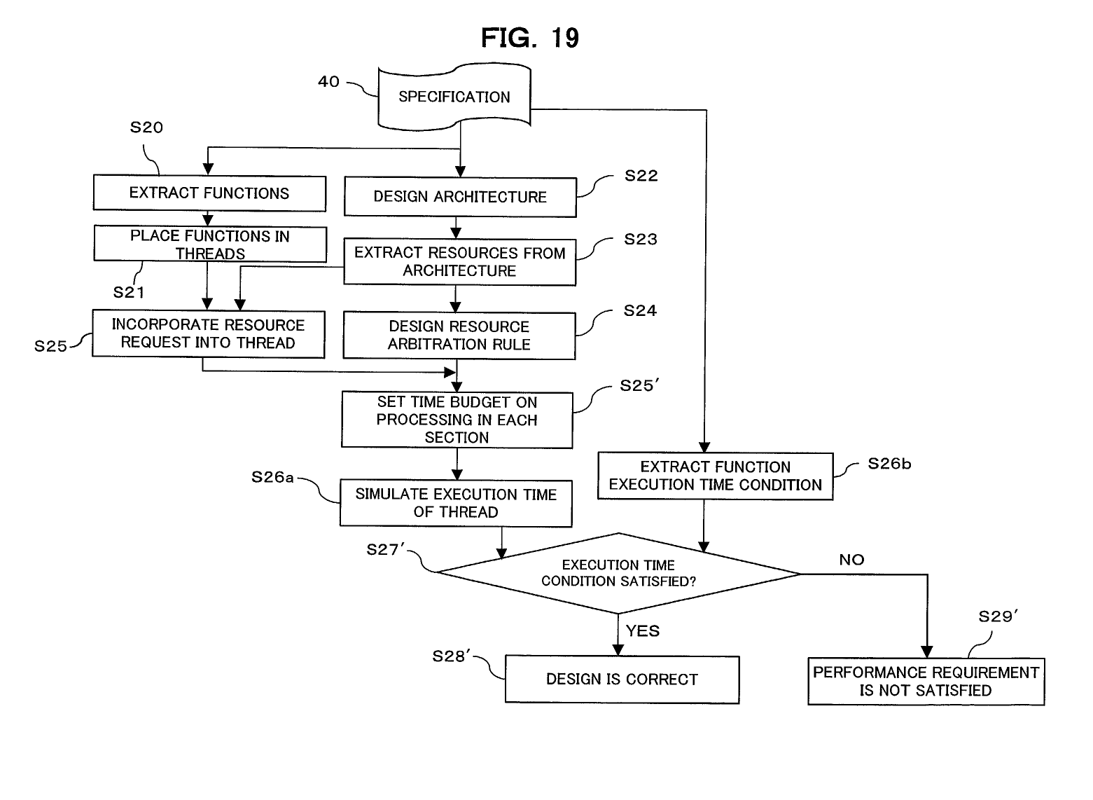

That is, when resources 14 are extracted from an architecture to map processing in each of the resources 14 as mentioned above with reference to FIG. 8 (after a resource request is incorporated into a thread 13 in the step S24), an estimated time (time budget) for each processing is added to the thread 13 (step S25′ in FIG. 19).

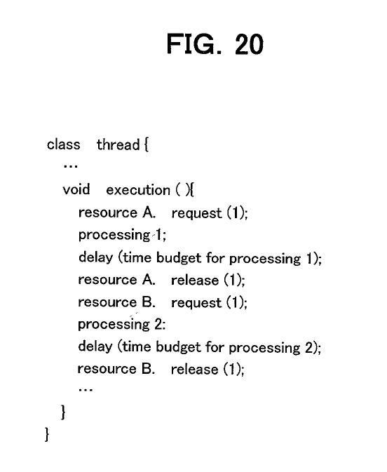

For example, as FIG. 20 shows, when the “functions” to be described in the thread 13 are taken as processing 1 and processing 2, delay (time budget for processing 1) and delay (time budget for processing 2) are set with respect to the processing 1 and the processing 2, respectively.

In addition, a limit on an execution time for when a logical unit processes n input data on the basis of a specification 40 is taken as T (step S26b in FIG. 19), and n data are generated from a test bench 15 to conduct a simulation as mentioned above (step S26a).

Thereafter, a time t taken until all the threads 13 disappear is measured, and if the measured time t is shorter than a limiting time T, it is possible to make a decision that the design is correct (step S28′ through YES route from step S27′ in FIG. 19). On the other hand, if the measured time t is longer than the limiting time T, a decision can be made that the performance requirements of the specification 40 do not reach satisfaction (step S29′ through NO route from step S27′ in FIG. 19).

Thus, at an initial stage of the design, it becomes possible to confirm whether or not a logical unit constructed with a combination of various types of “functions” satisfies the performance requirements on the specification 40.

(G) Description of Sixth Modification

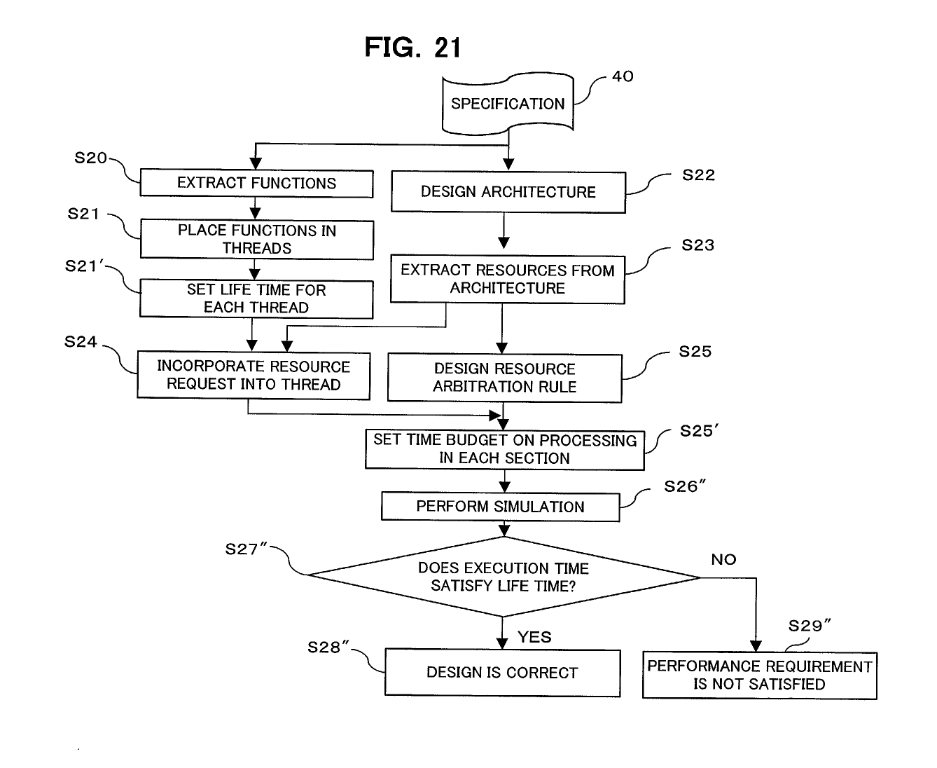

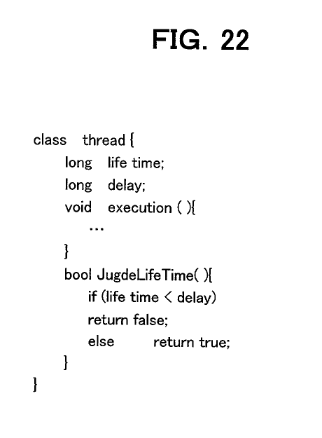

In addition, it is also appropriate that, for example, as shown in FIG. 21, before a resource request is incorporated into a thread 13 in the step S24, a “life time” is set with respect to the thread 13 as shown in FIG. 22 (step S21′). In this case, the “life time” denotes an execution limiting time on “function”.

After a “time budget” is set in a thread 13 (step S25′) as mentioned above in the fifth modification, when a simulation is made (step S26″) and a “JudgeLifeTime( )” function (see FIG. 22) is accessed (for example, from the resource manager 12) before the thread 13 disappears, in addition to the performance verification of the logical unit based on the aforesaid “time budget”, a decision can be made as to whether or not the “life time” set in the thread 13 is over, that is, whether or not the processing reaches completion within the “life time” (step S27″).

If the decision result shows the completion of the processing on the thread 13 within the “life time”, a decision can be made that the logical unit satisfies the performance requirements on the real-time characteristic prescribed in a specification 40 (that the design is correct) (step S28″ through YES route from step S27″). On the other hand, if the processing does not reach completion, a decision can be made to no satisfaction of the performance requirements on the real-time characteristic (step S29′′).

As stated above, in this modification, since the “time budget” and the “life time” are set in a thread 13, it is possible to verify, at an initial stage of design of a logical unit, performance requirements on a processing time of the entire logical unit comprising a combination of various types of “functions” and performance requirements on a real-time characteristic.

Incidentally, in this modification, although both the “time budget” and “life time” are set, naturally, it is also acceptable that only the “life time” is set to verify only the real-time characteristic of the logical unit.

In addition, although the “time budget” and “life time” are set in a thread 13 in the above-mentioned example, it is also possible to describe them in a resource 14. For example, in a case in which the data holding time is determined with respect to a storage device such as a memory or buffer, one of or both the time budget” and “life time” can be described in relation to that storage device (resource).

(H) Description of Seventh Modification

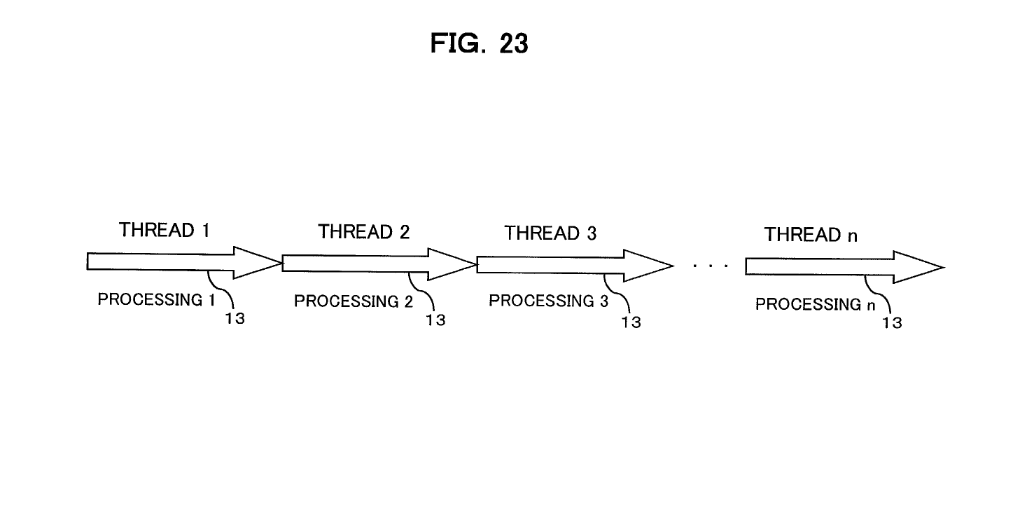

In the above-mentioned embodiment, although a series of processing (functions) needed until an operation of a logical unit comes to an end are represented in one thread 13, the “series of processing” can also be represented in a plurality of sequential or consecutive threads 13 (threads “1” to thread “n” ), for example, as illustratively shown in FIG. 23.

In this case, the operation is as follows. That is, the thread manager 11 generates a first thread “1” on the basis of an external input (input of test data 16). This thread “1” implements the processing “1” and makes a request to the resource manager 12 for a resource 14 needed for the processing “1”.

Whereupon, the resource 14 is allocated to the thread “1”, so the thread “1” completes the processing “1” and the thread manager 11 makes the thread “1” disappear. At this time, the thread “1” generates the next thread “2”. On the other hand, in the case of no allocation of the resource 14, that thread 13 is controlled into a “wait state” by the thread manager 11.

Thereafter, when a thread “i” (i=1 to n-1) disappears, the thread “i” generates the next thread “i+1”. Thus, a series of processing from input to a logical unit and completion of the operation thereof are expressed with a series of sequential threads 13. That is, in this modification, the generation of threads 13, to be made by the thread manager 11, is also made by the threads 13.

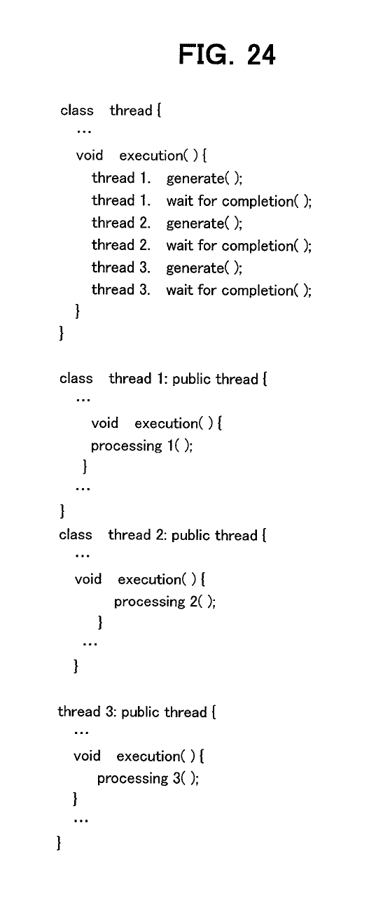

Concretely, for realizing this, for example, as shown in FIG. 24, to a thread 13, there are added a “method” of “wait for completion( )” and thread “1”, thread “2”, thread “3”, . . . respectively corresponding to processing “1 ”, processing “2”, processing “3”, . . .

Accordingly, the thread 13 is generated one by one in relation to the processing “1”, “2”, “3”, . . . and the generation timing of each of the threads 13 is set after the completion of the processing by the previous thread 13. This makes clearer the dependence among the threads 13 as compared with the above-mentioned embodiment.

In addition, the thread 13 thus constructed is incorporated into the system mentioned above with reference to FIG. 3 and a simulation for the logical unit is made at an initial design stage. That is, also in this case, the thread manager 11 and the resource manager 12 repeatedly conduct the request for a resource 14, the allocation of the resource 14 and the control of the execution condition of the thread 13 according to the resource 14 allocation result in cooperation with each other until the processing by all the threads 13 reaches completion (until all the threads 13 disappear), thus realizing a simulation of the operation of the logical unit.

As stated above, since, for a simulation, a series of processing from the input to the logical unit to the operation completion thereof are represented in a series of sequential threads 13, it is possible to accomplish the function verification thereof at an initial design stage while making clear the dependence among the processing needed in the logical unit.

(I) Description of Eighth Modification

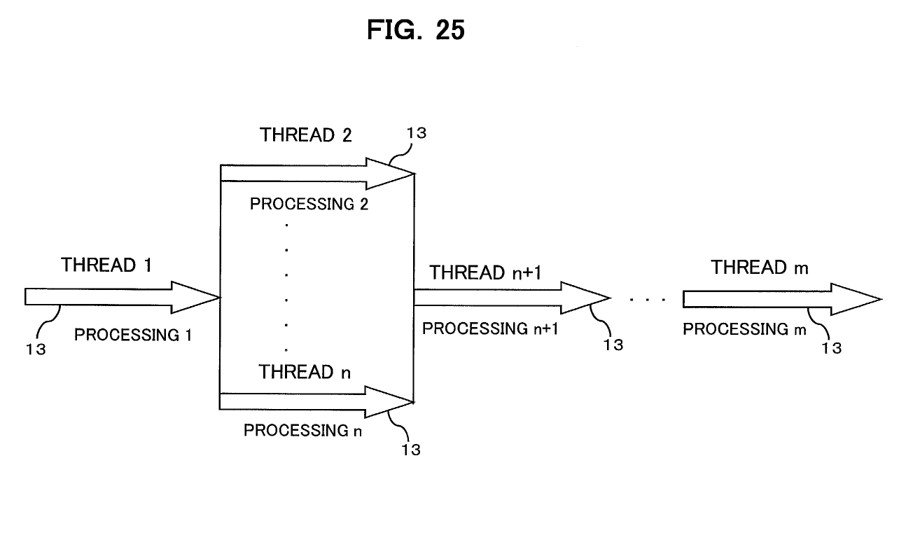

Furthermore, it is also appropriate that the aforesaid series of processing up to the completion of the operation of the logical unit are represented with a plurality of threads 13 executed sequentially or concurrently, for example, as illustratively shown in FIG. 25. That is, when a thread 13 disappears as mentioned above in the seventh modification, this thread 13 generates a plurality of threads 13 to execute the respective threads 13 in parallel, and when the plurality of threads 13 disappear, the subsequent threads 13 are generated successively.

In this case, the operation is as follows. That is, the thread manager 11 generates a first thread “1” on the basis of an external input (input of test data 16). The thread “1” conducts processing “1” and makes a request to the resource manager 12 for a resource 14 needed for the processing “1”. After the resource 14 is allocated to the thread “1” and the thread “1” completes the processing “1”, when the thread manager 11 makes the thread “1” disappear, the thread “1” generates the following threads “2” to “n” simultaneously. On the other hand, in the case of no allocation of the resource 14, that thread is controlled into the “wait state” by the thread manager 11.

Following this, the threads “2” to “n” conduct the processing concurrently, and when the processing reach completion and the thread manager 11 makes the threads “2” to “n” disappear, the next thread “n+1” appears. Thereafter, as in the case of the above-mentioned seventh modification, when the previous threads 13 disappear, the subsequent threads 13 are generated successively to conduct the processing.

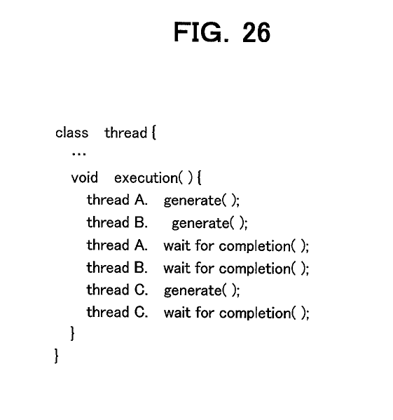

For example, in a case in which the processing C uses the implementation results of the processing A and B, a thread 13 is constructed, for example, as shown in FIG. 26. Also in this case, the thread 13 thus constructed is applied to the system mentioned above with reference to FIG. 3 to perform a simulation on a logical unit at an initial design stage.

That is, the thread manager 11 and the resource manager 12 repeatedly implement the request for a resource 14, the allocation for the resource 14 and the control of the execution state of the thread 13 according to the resource 14 allocation result in cooperation with each other until the processing by all the threads 13 reach completion (until all the threads 13 disappear), thus realizing a logical unit operation simulation.

As stated above, in this modification, the parallel processing is introduced into a thread 13 to conduct the processing in parallel, thus enabling a simulation on an operation of a logical unit having more complicated “functions” as compared with those in the above-mentioned embodiment or seventh modification.

(J) Description of Ninth Modification

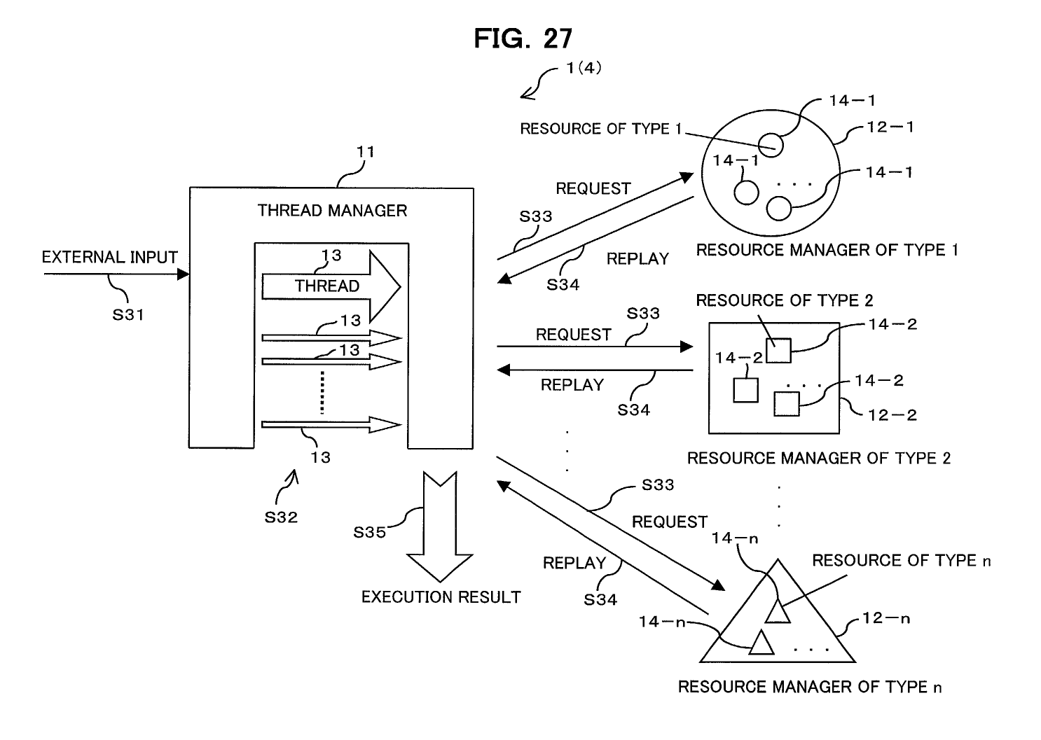

Furthermore, although the aforesaid resource manager 12 manages all the resources 14 in common irrespective of type of the resources 14, it is also appropriate that, for example, as illustratively shown in FIG. 27, resource managers 12-1 to 12-n are provided with respect to a plurality of types of resources 14-1 to 14-n, respectively, and each of the resource managers 12-1 to 12-n manages one type of resource 14-j (j=1 to n) independently (locally) for allocating a resource 14-j meeting a request 19 to the request issuing thread 13 in accordance with a local “arbitration rule”.

In this case, the computer 1 (CPU 4) can be operated as follows. That is, the thread manager 11 generates a thread 13 (step S32) on the basis of an external input (input of test data 16; step S31). Although the thread 13 forwards the processing independently, the individual execution order is similarly managed by the thread manager 11. In addition, if, for advancing the processing, there is a need to secure a resource 14-j, the thread 13 makes a request through the thread manager 11 to the corresponding resource manager 12-j for securing that resource 14-j (step S33; resource requesting step).

The resource manager 12-j locally arbitrates resource requests within a unit time on each resource 14-j and issues the resource 14-j allocation result as a reply 21 to the thread manager 11 (step S34; resource allocating step). The thread manager 11 controls the execution state of the thread 13 on the basis of the reply 21 from the resource manager 12-j (thread control step).

Also in this case, as mentioned above with reference to FIG. 3, the thread manager 11 and the resource manager 12-j repeatedly conduct the resource request, the resource allocation and the thread 13 control in cooperation with each other until the processing by all the threads 13 reach completion, thereby outputting an execution result (step S35) and realizing a logical unit operation simulation.

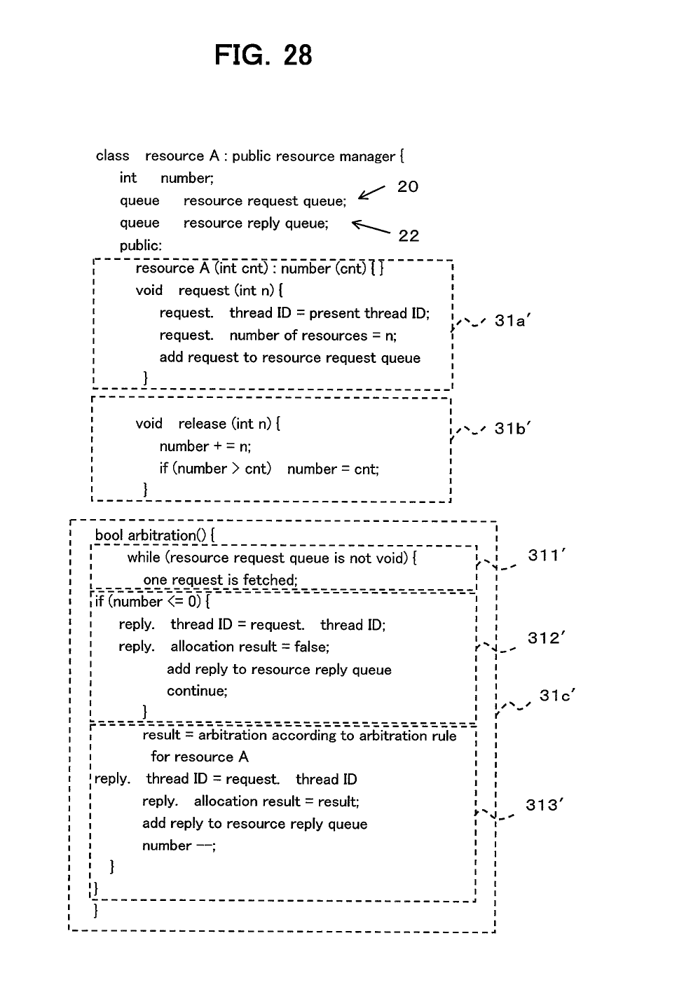

Concretely, if the resources are of three types A, B and C (which will be referred to hereinafter as resources A, B and C), the resource A the resource manager 12-j manages (refers to) is constructed (described), for example, as shown in FIG. 28 in the C++ description style. That is, this defines not only the aforesaid resource request queue 20 and resource reply queue 22 but also a request method 31a′ a release method 31b′ for making the release of the resource A and an arbitration method 31c′ for making arbitration on the resource A.

The request method 31a′ is a function for conducting an operation to register the requested resource A and the thread ID of the thread 13 issuing that request 19 as a request message in the resource request queue 20, while the release method 31b′ a function for releasing the resource A and for incrementing the number of released resources A by one.

In addition, the arbitration method 31c′ is a function for arbitrating the allocation of the resource A independently (locally), and except that the resource request queue 20 is void, the requests 19 are fetched one by one from the resource request queue 20 by the description in the broken line frame 311′, and if the number of requested resources A is equal to or less than zero at that time, the description in a broken line frame 312′ is implemented, while if the number of requested resources A is equal to or more than one at that time, the description in a broken line frame 313′ is implemented.

That is, if the number of requested resources A is equal to or less than zero at that time, since no resource A to be allocated newly exists, “False” is stored as a reply 21 on the resource allocation result in the resource reply queue 22. On the other hand, if the number of requested resources A is equal to or more than one, since the allocation thereof is possible, the allocation is made in accordance with an arbitration rule for the resource A, and the arbitration (allocation) result (“True”) is stored as a reply 21 in the resource reply queue 22. In like manner (see FIG. 28), the description can be made with respect to the resource B and the resource C. That is, in this case, as compared with the case shown in FIG. 6, the description quantity becomes larger, but the structure becomes simpler.

When the resources A, B and C thus constructed are applied to the system shown in FIG. 3, the resource manager 12-j for each of the resource types performs the resource allocation in accordance with a local “arbitration rule” independent from the others, thus accomplishing a simulation of the logical unit in a state where dependence does not exist among the resource types A, B and C.

(K) Description of Tenth Modification

The above-mentioned ninth modification handles a case in which dependence does not exist among resource types. However, if the dependence exists, the foregoing local arbitration does not show full satisfaction. For example, in a case in which a resource “CPU” is composed of resources including an “Arithmetic Logic Unit (ALU)”, a “BUS” and a “REGISTER” and the resource “ALU” is composed of resources including an “ADDER”, a “SUBTRACTER”, an “AND” and an “OR”, the allocation of the resource “CPU” to a thread 13 requires that the resources “ALU”, “BUS”, “REGISTER”, “ADDER”, “AND” and “OR” constituting the lower hierarchies are also free.

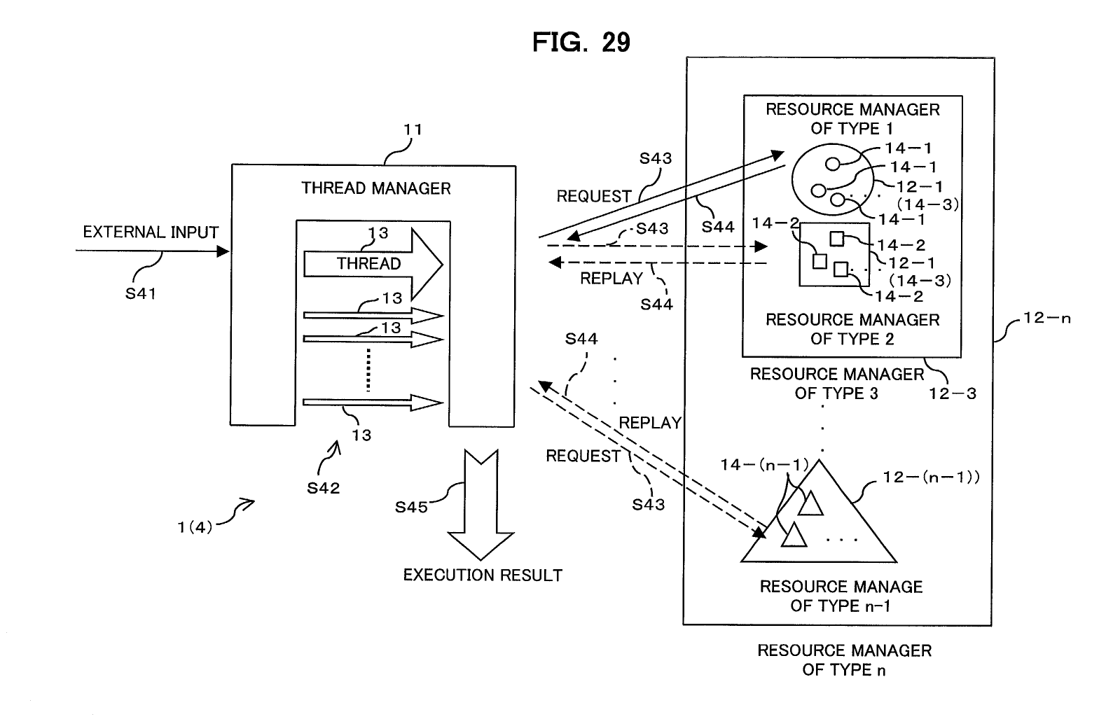

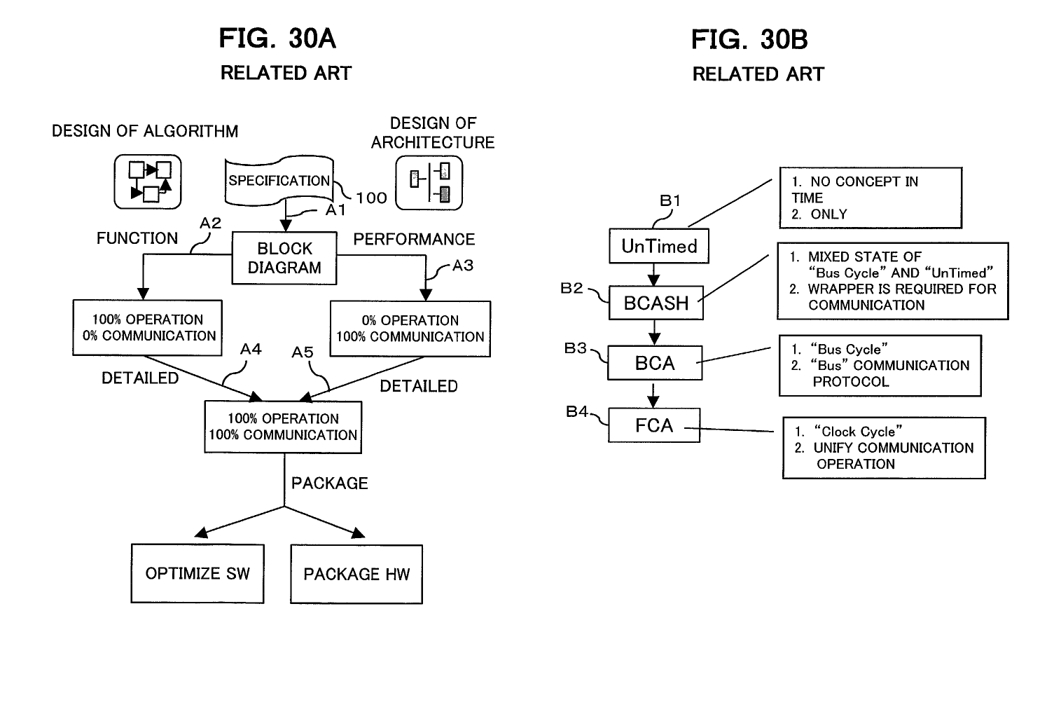

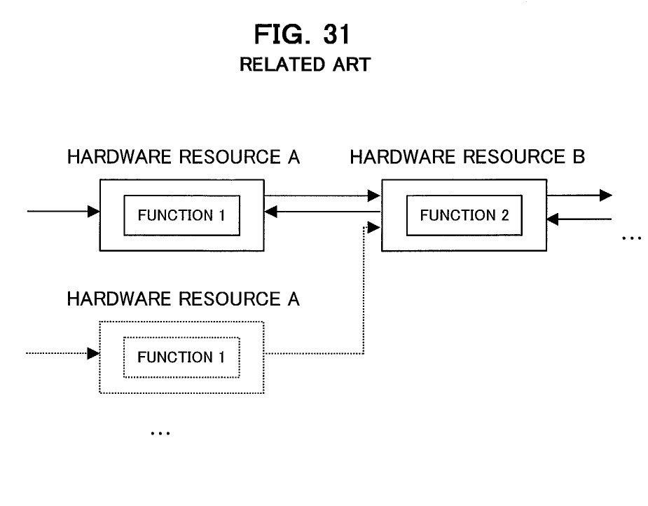

Thus, when the dependence of the resources 14-j exists, the resource managers 12-j are hierarchically related to each other according to the dependence, for example, as illustratively shown in FIG. 29.

That is, in the case shown in FIG. 29, since the dependence does not exists between the resource 14-1 and the resource 14-2, the resource managers 12-1 and 12-2 locally manage the resources 14-1 and 14-2, respectively. On the other hand, since the dependence exists between the resources 14-1, 14-2 and the resource 14-3, the higher-hierarchy resource manager 12-3 also manages the lower-hierarchy resource managers 12-1 and 12-2, thereby managing the lower-hierarchy resources 14-1 and 14-2.

In like manner, the resource managers 12-3 and 12-(n-1) locally and independently manage the resources 14-3 and 14-(n-1). In this case, since these show the dependence with respect to the higher-hierarchy resource 14-n, the higher-hierarchy resource manager 12-n manages the lower-hierarchy resource managers 12-3 and 12-(n-1).

As stated above, in a case in which the resources 14-j have the dependence and the aforesaid local resource arbitration is not useful, the resources 14-j are hierarchically related to each other for achieving a global resource arbitration.

In this case, the computer 1 (CPU 4) operates as follows. That is, the thread manager 11 generates a thread 13 (step S42) on the basis of an external input (input of test data 16; step S41). Similarly, the thread 13 forwards the processing independently, and the individual execution order is under management of the thread manager 11.

In addition, when there is a need to secure a resource 14-j for forwarding the processing, the thread 13 makes a request through the thread manager 1 to the resource manager 12-j for that resource type for securing the resource 14-j (step S43; resource request step).

The resource manager 12-j locally arbitrates the allocation on each of the resources 14-j in response to the resource requests within a unit time. The local allocation result on the resource 14-j is communicated to the higher-hierarchy resource manager 12-k (k=j+1) so that the high-hierarchy resource manager 12-k determines that hierarchy resource allocation in consideration of the allocation result on the resource 12-k of a type involved (having the dependence).

Thereafter, in like manner, the lower-order hierarchy resource allocation results are successively communicated to the higher hierarchies, and lastly the highest-hierarchy resource manager 12-n gives a reply on the final allocation result to the thread manager 11 (step S44; resource allocation step).

That is, in this modification, in the resource allocating step S44, the higher-hierarchy resource manager 12-k performs the resource allocation in consideration of the dependence between the resource 14-k it manages and the resource 14-j the lower-hierarchy resource manager 12-j manages.

In addition, the thread manager 11 controls the execution state on the thread 13 on the basis of the reply 21 from the resource manager 12-j (thread control step). Following this, the thread manager 11 and the resource manager 12-j repeatedly conduct the aforesaid resource request, resource allocation and control of the thread 13 in cooperation with each other until the processing by all the threads reach completion, and output the execution result (simulation result) (step S45), thus realizing a simulation on the logical unit.

As stated above, in this modification, since the resources 14-j and the resource managers 12-j are hierarchically related to each other in accordance with the dependence of the resources 14-j, the higher-hierarchy resource managers 12-j can conduct the allocation of the resources 14-j while reflecting the resources 14-j the lower-hierarchy resource managers 12-j manage, so the global arbitration among the resource types becomes feasible, thus realizing a simulation on an operation of a logical unit having more complicated dependence and enabling the verification on functions or performance at an initial design stage.

As a matter of course, the above-described seventh to tenth modifications are also applicable to any one of the above-described first to sixth modifications, and each combination can offer advantages and effects.

As mentioned above, with the logical unit operation simulation methods according to this embodiment and the modifications thereof, the function-level simulation is achievable at an initial stage of design of a logical unit, which allows the “functions” and the acceptability of an architecture for realizing the “functions” to be confirmed at an initial design stage to accomplish the function verification and performance evaluation of the logical unit.

In addition, it is possible to confirm whether or not the “functions” have been realized at an initial design stage, and further to confirm the safety of the design. What's more, when the architecture is required to alter, it is possible to easily re-verify the design simply by changing the resource 14 (14-j), the “arbitration rule”, the resource request and others, so an increase in design cost stemming from a change in description about the “functions” is avoidable unlike the conventional method.

(L) Others

In the above-described embodiment and modifications thereof, although the C++ description style has been employed as a concrete description example on the simulating program 10, naturally, it is also possible to use a description style based on another programming language such as Java, and also in this case, the similar effects are attainable.

It should be understood that the present invention is not limited to the above-described embodiments, and that it is intended to cover all changes and modifications of the embodiments of the invention herein which do not constitute departures from the spirit and scope of the invention.

What is claimed is:

1. A method of simulating an operation of a logical unit, comprising:
a resource requesting step in which a thread manager, which controls threads each forming an execution unit of a program, makes a request for a hardware resource needed for execution of each of threads representative of a series of functions required until the operation of said logical unit reaches completion according to a design specification of said logical unit, to a resource manager which manages said hardware resource;
are source allocating step in which said resource manager allocates said hardware resource meeting said request to said thread in accordance with a rule prescribed in advance; and
a thread control step in which said thread manager controls an execution state of said thread in accordance with a result of the allocation made by said resource manager,
said thread manager and said resource manager executing said steps repeatedly in cooperation with each other until the execution of said thread reaches completion, for simulating the operation of said logical unit to be conducted up to the completion.

2. A method of simulating an operation of a logical unit according to claim 1, wherein said series of functions are represented in a plurality of sequential threads.

3. A method of simulating an operation of a logical unit according to claim 1, wherein said series of functions are represented in a plurality of sequential or concurrently executed threads.

4. A method of simulating an operation of a logical unit according to claim 1, wherein a plurality of resource managers each corresponding to said resource manager are provided in conjunction with the types of said hardware resources, and
in said resource allocating step, each of said resource managers allocates said hardware resource, said resource manager manages, to said thread in accordance with a local rule described in advance.

5. A method of simulating an operation of a logical unit according to claim 1, wherein a plurality of resource managers each corresponding to said resource manager are provided in conjunction with the types of said hardware resources and are hierarchized according to the dependence among said hardware resources, and
in said resource allocating step, the hardware resource allocation is made in consideration of the dependence between said hardware resource managed by one of said resource managers manages and said hardware resource managed by the other resource manager lower in hierarchy than the one of said resource managers.

6. A method of simulating an operation of a logical unit according to claim 1, wherein said resource manager monitors resource requests in said resource requesting step to make a decision on a resource request deadlock state among a plurality of threads on a result of the monitoring.

7. A method of simulating an operation of a logical unit according to claim 1, wherein said resource manager monitors read/write requests with respect to said hardware resource allocated by said resource request in said resource requesting step to make a decision on a competition state in read/write operation on said hardware resource among a plurality of threads on the basis of a result of the monitoring.

8. A method of simulating an operation of a logical unit according to claim 1, wherein said resource manager monitors the number of resource requests with respect to said hardware resource to detect a bottleneck on said thread on the basis of a result of the monitoring.

9. A method of simulating an operation of a logical unit according to claim 1, wherein said resource manager monitors the number of resource requests with respect to said hardware resource to detect blocking of said resource requests on the basis of a result of the monitoring.

10. A method of simulating an operation of a logical unit according to claim 1, wherein said thread has a budget on a time of occupancy of a hardware resource allocated by said resource manager.

11. A method of simulating an operation of a logical unit according to claim 1, wherein said thread has an execution time-limit on said function.

12. A method of simulating an operation of a logical unit, comprising:
a resource requesting step in which a thread manager, which controls threads each forming an execution unit of a program, makes a request for a hardware resource needed for execution of each of a series of threads representative of functions required until the operation of said logical unit reaches completion according to a design specification of said logical unit, to a resource manager which manages said hardware resource;
a resource allocating step in which said resource manager allocates said hardware resource meeting said request to said thread in accordance with a rule prescribed in advance;
a thread control step in which said thread manager controls an execution state of said thread in accordance with a result of the allocation made by said resource manager,
with said thread manager and said resource manager executing said steps repeatedly in cooperation with each other until the execution of said thread reaches completion, for simulating the operation of said logical unit to be conducted up to the completion,
said method further comprising:
a comparison step of comparing a result of the simulation with an estimated value on said operation of said logical unit; and
an output step of outputting a result of the comparison in said comparison step to an external unit.

13. An apparatus for simulating an operation of a logical unit, comprising:
a thread manager for controlling a thread forming an execution unit of a program; and
a resource manager for managing a hardware resource needed for execution of said thread,
said thread manager including:
resource requesting means for making a request for a hardware resource needed for execution of a thread representative of functions required until the operation of said logical unit reaches completion according to a design specification of said logical unit, to said resource manager; and
thread control means for controlling an execution state of said thread in accordance with a result of a resource allocation made by said resource manager in response to the request from said resource requesting means,
said resource manager including:
resource allocating means for allocating a hardware resource meeting the request to said thread in accordance with a rule prescribed in advance,
said thread manager and said resource manager conducting the resource request and the control of the thread execution state repeatedly in cooperation with each other until the execution of said thread reaches completion, for simulating the operation of said logical unit to be conducted up to the completion.

14. A computer readable recording medium retaining a program for simulation of an operation of a logical unit,
said simulation program making a computer function as a thread manager for controlling threads each forming an execution unit of said program and as a resource manager for managing a hardware resource needed for execution of each of threads, and
said simulation program executing:
a resource requesting step in which said thread manager makes a request for a hardware resource needed for execution of threads representative of a series of functions required until the operation of said logical unit reaches completion according to a design specification of said logical unit, to said resource manager;
a resource allocating step in which said resource manager allocates said hardware resource meeting the request to said thread in accordance with a rule prescribed in advance; and
a thread control step in which said thread manager controls an execution state of said thread in accordance with a result of the allocation made by said resource manager,
said thread manager and said resource manager executing said steps repeatedly in cooperation with each other until the execution of said thread reaches completion, for simulating the operation of said logical unit to be conducted up to the completion.

15. A computer readable recording medium retaining a program for simulation of an operation of a logical unit according to claim 14, wherein a plurality of resource managers each corresponding to said resource manager are provided in conjunction with the types of hardware resources, and
in said resource allocating step, each of said resource managers allocates said hardware resource, said resource manager manages, to said thread in accordance with a local rule described in advance.

16. A computer readable recording medium retaining a program for simulation of an operation of a logical unit according to claim 14, wherein a plurality of resource managers each corresponding to said resource manager are provided in conjunction with the types of hardware resources and are hierarchized according to the dependence among said hardware resources, and
in said resource allocating step, the hardware resource allocation is made in consideration of the dependence between said hardware resource managed by one of said resource managers and said hardware resource managed by the other resource manager lower in hierarchy than the one of said resource managers.

17. A computer readable recording medium retaining a program for simulation of an operation of a logical unit according to claim 14, wherein said resource manager monitors resource requests in said resource requesting step to make a decision on a resource request deadlock state among a plurality of threads on a result of the monitoring.

18. A computer readable recording medium retaining a program for simulation of an operation of a logical unit according to claim 14, wherein said resource manager monitors read/write requests with respect to said hardware resource allocated by said resource request in said resource requesting step to make a decision on a competition state in read/write operation on said hardware resource among a plurality of threads on the basis of a result of the monitoring.

19. A computer readable recording medium retaining a program for simulation of an operation of a logical unit according to claim 14, wherein said resource manager monitors the number of resource requests with respect to said hardware resource to detect a bottleneck on said thread on the basis of a result of the monitoring.

20. A computer readable recording medium retaining a program for simulation of an operation of a logical unit according to claim 14, wherein said resource manager monitors the number of resource requests with respect to said hardware resource to detect blocking of said resource requests on the basis of a result of the monitoring.

21. A computer readable recording medium retaining a program for simulation of an operation of a logical unit according to claim 14, wherein said thread has a budget on a time of occupancy of a hardware resource allocated by said resource manager.

22. A computer readable recording medium retaining a program for simulation of an operation of a logical unit according to claim 14, wherein said thread has an execution time-limit on said function.

23. A computer readable recording medium retaining a program for simulation of an operation of a logical unit according to claim 14, wherein said series of functions are represented in a plurality of sequential threads.

24. A computer readable recording medium retaining a program for simulation of an operation of a logical unit according to claim 23, wherein a plurality of resource managers each corresponding to said resource manager are provided in conjunction with the types of hardware resources, and
in said resource allocating step, each of said resource managers allocates said hardware resource, said resource manager manages, to said thread in accordance with a local rule described in advance.

25. A computer readable recording medium retaining a program for simulation of an operation of a logical unit according to claim 23, wherein a plurality of resource managers each corresponding to said resource manager are provided in conjunction with the types of hardware resources and are hierarchized according to the dependence among said hardware resources, and
in said resource allocating step, the hardware resource allocation is made in consideration of the dependence between said hardware resource managed by one of said resource managers and said hardware resource managed by the other resource manager lower in hierarchy than the one of said resource managers.

26. A computer readable recording medium retaining a program for simulation of an operation of a logical unit according to claim 23, wherein said resource manager monitors resource requests in said resource requesting step to make a decision on a resource request deadlock state among a plurality of threads on a result of the monitoring.

27. A computer readable recording medium retaining a program for simulation of an operation of a logical unit according to claim 23, wherein said resource manager monitors read/write requests with respect to said hardware resource allocated by said resource request in said resource requesting step to make a decision on a competition state in read/write operation on said hardware resource among a plurality of threads on the basis of a result of the monitoring.

28. A computer readable recording medium retaining a program for simulation of an operation of a logical unit according to claim 23, wherein said resource manager monitors the number of resource requests with respect to said hardware resource to detect a bottleneck on said thread on the basis of a result of the monitoring.

29. A computer readable recording medium retaining a program for simulation of an operation of a logical unit according to claim 23, wherein said resource manager monitors the number of resource requests with respect to said hardware resource to detect blocking of said resource requests on the basis of a result of the monitoring.

30. A computer readable recording medium retaining a program for simulation of an operation of a logical unit according to claim 23, wherein said thread has a budget on a time of occupancy of a hardware resource allocated by said resource manager.

31. A computer readable recording medium retaining a program for simulation of an operation of a logical unit according to claim 23, wherein said thread has an execution time-limit on said function.

32. A computer readable recording medium retaining a program f or simulation of an operation of a logical unit according to claim 14, wherein said series of functions are represented in a plurality of sequential or concurrently executed threads.

33. A computer readable recording medium retaining a program for simulation of an operation of a logical unit according to claim 32, wherein a plurality of resource managers each corresponding to said resource manager are provided in conjunction with the types of hardware resources, and
in said resource allocating step, each of said resource managers allocates said hardware resource, said resource manager manages, to said thread in accordance with a local rule described in advance.

34. A computer readable recording medium retaining a program for simulation of an operation of a logical unit according to claim 32, wherein a plurality of resource managers each corresponding to said resource manager are provided in conjunction with the types of hardware resources and are hierarchized according to the dependence among said hardware resources, and
in said resource allocating step, the hardware resource allocation is made in consideration of the dependence between said hardware resource managed by one of said resource managers and said hardware resource managed by the other resource manager lower in hierarchy than the one of said resource managers.

35. A computer readable recording medium retaining a program for simulation of an operation of a logical unit according to claim 32, wherein said resource manager monitors resource requests in said resource requesting step to make a decision on a resource request deadlock state among a plurality of threads on a result of the monitoring.

36. A computer readable recording medium retaining a program for simulation of an operation of a logical unit according to claim 32, wherein said resource manager monitors read/write requests with respect to said hardware resource allocated by said resource request in said resource requesting step to make a decision on a competition state in read/write operation on said hardware resource among a plurality of threads on the basis of a result of the monitoring.

37. A computer readable recording medium retaining a program for simulation of an operation of a logical unit according to claim 32, wherein said resource manager monitors the number of resource requests with respect to said hardware resource to detect a bottleneck on said thread on the basis of a result of the monitoring.

38. A computer readable recording medium retaining a program for simulation of an operation of a logical unit according to claim 32, wherein said resource manager monitors the number of resource requests with respect to said hardware resource to detect blocking of said resource requests on the basis of a result of the monitoring.

39. A computer readable recording medium retaining a program f or simulation of an operation of a logical unit according to claim 32, wherein said thread has a budget on a time of occupancy of a hardware resource allocated by said resource manager.

40. computer readable recording medium retaining a program for simulation of an operation of a logical unit according to claim 32, wherein said thread has an execution time-limit on said function.

41. A computer readable recording medium retaining a program for simulation of an operation of a logical unit,
said simulation program making a computer execute:
a resource requesting step in which a thread manager, which controls threads each forming an execution unit of a program, makes a request for a hardware resource needed for execution of each of threads representative of functions required until the operation of said logical unit reaches completion according to a design specification of said logical unit, to a resource manager which manages said hardware resource;
a resource allocating step in which said resource manager allocates said hardware resource meeting said request to said thread in accordance with a rule prescribed in advance;
a thread control step in which said thread manager controls an execution state of said thread in accordance with a result of the allocation made by said resource manager,
said thread manager and said resource manager executing said steps repeatedly in cooperation with each other until the execution of said thread reaches completion, for simulating the operation of said logical unit to be conducted up to the completion, and
said method further comprising:
a comparison step of comparing a result of the simulation with an estimated value on said operation of said logical unit; and
an output step of outputting a result of the comparison in said comparison step to an external unit.
